(19) United States
(12) Patent Application Publication
(10) Pub. No.: US 2022/0158974 A1
(43) Pub. Date: May 19, 2022

(54) Security Management for Internet-Of-Things Devices

(71) Applicant: AT&T Intellectual Property I, L.P., Atlanta, GA (US)

(72) Inventors: Wei Wang, Harrison, NJ (US); Cristina Serban, Sarasota, FL (US)

(73) Assignee: AT&T Intellectual Property I, L.P., Atlanta, GA (US)

(21) Appl. No.: 17/097,078

(22) Filed: Nov. 13, 2020

(51) Int. Cl. H04L 29/06

(52) U.S. Cl. CPC H04L 63/029

(57) ABSTRACT

Security management for Internet-of-things devices can include device-level security, hub-level security, and service-level security. Internet-of-things devices can communicate threats to each other and/or to an Internet-of-things hub on a gateway. The gateway can receive a communication associated with an Internet-of-things device, the communication request including a request for the Internet-of-things device to connect with another device. Based on connection data included in security communications received from the Internet-of-things device, the gateway can determine if the communication associated with the Internet-of-things device should be allowed. If the communication associated with the Internet-of-things device should not be allowed, an action can be taken to limit the communication, If the communication should be allowed, the communication can be allowed.

### BACKGROUND

With the proliferation of the Internet-of-things (also referred to as the “IoT”) domain has come a thing-on-thing attack approach. In particular, Internet-of-things devices may be enabled now through installed or acquired malware to communicate with other Internet-of-things devices to perform malicious actions such as spying, harassment, or the like. Some of these attacks may not be detectable by existing malware detection technologies.

Because Internet-of-things devices have not historically posed a pronounced threat to networks, Internet-of-things devices may be able to exploit their time and proximity to other Internet-of-things devices or Internet-of-things networks to propagate malware from one device to another. Thus, for example, a car in a parking garage at an office building may have seven to eight uninterrupted hours to discover nearby devices and/or to attempt to propagate malware to those devices (e.g., other parked cars in the parking deck), and these devices may propagate the malware to other Internet-of-things devices at a home, or the like, when driven home and parked for the night.

Because the Internet-of-things devices may act independently, some thing-on-thing attacks may not be recognizable as a botnet, etc., and therefore existing tools may be unable to detect some thing-on-thing attacks. The traffic patterns may not be uniform, large volume, or have a unified target, and therefore may be difficult to detect.

### SUMMARY

The present disclosure is directed to security management for Internet-of-things devices. One or more Internet-of-things devices can communicate with each other and/or other devices via an Internet-of-things network. In some embodiments, the Internet-of-things network can include an Internet-of-things hub, which can be executed and/or hosted by a gateway. Thus, the Internet-of-things devices can communicate with each other, with the Internet-of-things hub, and/or with other devices or resources (e.g., a resource such as a website, application, or the like) via the gateway. One or more of the Internet-of-things devices can include a security application for managing security of the Internet-of-things devices and a hardware selector, which may be used during an onboarding process and/or at other times to verify that a user or other entity has requested a particular operation associated with the Internet-of-things device.

In some embodiments, one or more of the Internet-of-things devices can be installed with and/or infected with a malware. The malware may attempt to conduct communications via the Internet-of-things network and/or to infect other Internet-of-things devices or other devices on the Internet-of-things network or in a proximity of the Internet-of-things device on which the malware is operating. According to some embodiments, a gateway or other device can include an Internet-of-things hub. The Internet-of-things hub can be configured to provide hub-level security for the Internet-of-things network, for example by monitoring communications among and/or from the Internet-of-things devices to each other, the gateway, and/or external devices such as the resource. The Internet-of-things hub can be configured to exchange security communications with the Internet-of-things devices to onboard the Internet-of-things devices, to allow and/or block communications via the Internet-of-things hub, to obtain connection data associated with the Internet-of-things devices, and/or for other reasons.

The Internet-of-things hub can be configured to analyze communications occurring via the gateway and/or among devices on the Internet-of-things network to determine if communications are expected, unexpected, legitimate, malicious, or the like. Thus, the Internet-of-things hub can, based on analysis of the communications and/or via analysis of one or more connection policies, identify potentially compromised Internet-of-things devices (e.g., Internet-of-things devices that are running the malware). The Internet-of-things hub can also be configured to generate display data. The display data can be rendered by a device (e.g., a user device) to present a user interface for managing the communications and/or providing alerts and/or monitoring information, and/or can be used to generate a portal at the Internet-of-things hub that can be accessed by the user device.

The user interface or portal can be interacted with by the user device or other entities to manage communications and/or devices associated with the Internet-of-things network. In some embodiments, the user device can detect manipulations of the user interface and send input to the Internet-of-things hub for acting on the detected manipulations. Alternatively, the Internet-of-things hub can detect manipulations via the portal. The Internet-of-things hub can manage the security of the Internet-of-things network by, for example, blocking communications, enabling communications, blocking devices, enabling devices, onboarding devices, combinations thereof, or the like. In various embodiments, the Internet-of-things hub can obtain updates for the Internet-of-things hub and/or for the Internet-of-things devices. Thus, the updates can update the connection policies, the firmware of Internet-of-things devices, software of the Internet-of-things devices such as the security application, and/or send other changes to Internet-of-things devices such as security patches, device lists, combinations thereof, or the like.

A such, it can be appreciated that the concepts and technologies disclosed herein can provide device-level security management for Internet-of-things devices, hub-level security for Internet-of-things devices, and/or service-level security management for Internet-of-things devices. Namely, the Internet-of-things devices can include a security application that can provide some level of security management at the device level, the Internet-of-things hub can provide some level of security management at the hub-level, and the security management service can provide security management at the service level such as a cloud-based or server-based service for enhancing security management of Internet-of-things devices. It should be understood that these examples are illustrative, and therefore should not be construed as being limiting in any way.

In contrast to intrusion detection systems (“IDS”) and/or intrusion prevention systems (“IPS”), which can be focused on large scale attacks, embodiments of the concepts and technologies disclosed herein can be configured to detect thing-on-thing attacks in more contained networks such as a network of devices belonging to a home or office network. Thus, embodiments of the concepts and technologies disclosed herein can be configured to detect targeted small fingerprint attacks among devices (e.g., Internet-of-things devices) that can be difficult to detect using conventional IDS/IPS technologies. Also, instead of merely using a central gateway (e.g., a gateway hosting an Internet-of-things hub) to detect attacks, embodiments of the concepts and technologies disclosed herein can also leverage detection on each Internet-of-things device itself (e.g., via execution of a security application or firmware feature by the Internet-of-things device). Thus, embodiments of the concepts and technologies disclosed herein can provide a crowd-based and/or crowd-sourced device-level security scheme for detection and/or mitigation. Some embodiments of the concepts and technologies disclosed herein can also enable users to actively participate in the detection and/or prevention system by physical confirmation and/or rejection when an Internet-of-things device requests to be onboarded to a network, as well as by managing what communication can occur by, to, and/or among devices. These and other features of the concepts and technologies disclosed herein will be illustrated and described in more detail herein.

According to one aspect of the concepts and technologies disclosed herein, a system is disclosed. The system can include a processor and a memory. The memory can store computer-executable instructions that, when executed by the processor, cause the processor to perform operations. The operations can include detecting, at the gateway using an Internet-of-things hub, a communication associated with an Internet-of-things device. The communication can include an attempt for the Internet-of-things device to communicate with another device. The operations further can include determining, by the gateway and based on connection data included in security communications received from the Internet-of-things device, if the communication associated with the Internet-of-things device should be allowed. In response to a determination that the communication associated with the Internet-of-things device should not be allowed, the operations can include taking, by the gateway, an action to limit the communication. In response to a determination that the communication should be allowed, the operations can include allowing, by the gateway, the communication.

In some embodiments, the Internet-of-things device communicates with the gateway via an Internet-of-things network that can include the Internet-of-things device and the gateway. In some embodiments, the Internet-of-things device can be onboarded by the gateway by performing operations including detecting an onboarding request from the Internet-of-things device; prompting the Internet-of-things device to obtain a hardware verification; and in response to determining that the hardware verification is received, onboarding the Internet-of-things device. In some embodiments, the hardware verification can include detecting manipulation of a hardware device to generate an input at the Internet-of-things device.

In some embodiments, the hardware verification can include verifying that an output by the hardware device has been detected at the Internet-of-things device. In some embodiments, the computer-executable instructions, when executed by the processor, can cause the processor to perform operations further including generating, at the gateway, display data including renderable data for presenting a user interface that depicts the communication; receiving, at the gateway, input including selection of a user interface element to modify an aspect of the communication; and triggering, by the gateway, blocking of the communication based on the input.

According to another aspect of the concepts and technologies disclosed herein, a method is disclosed. The method can include detecting, at a gateway including a processor that executes an Internet-of-things hub, a communication associated with an Internet-of-things device. The communication can include an attempt for the Internet-of-things device to communicate with another device. The method also can include determining, by the processor and based on connection data included in security communications received from the Internet-of-things device, if the communication associated with the Internet-of-things device should be allowed. In response to a determination that the communication associated with the Internet-of-things device should not be allowed, the method can include taking, by the processor, an action to limit the communication. In response to a determination that the communication should be allowed, the method can include allowing, by the processor, the communication.

In some embodiments, the Internet-of-things device can communicate with the gateway via an Internet-of-things network that can include the Internet-of-things device and the gateway. In some embodiments, the Internet-of-things device can be onboarded by the gateway by performing operations including detecting an onboarding request from the Internet-of-things device; prompting the Internet-of-things device to obtain a hardware verification; and in response to determining that the hardware verification is received, onboarding the Internet-of-things device.

In some embodiments, the hardware verification can include detecting manipulation of a hardware device to generate an input at the Internet-of-things device. In some embodiments, the hardware verification can include verifying that an output by the hardware device has been detected at the Internet-of-things device. In some embodiments, the hardware device can include one of a light device or a sound device.

In some embodiments, the method further can include generating, at the gateway, display data including renderable data for presenting a user interface that depicts the communication; receiving, at the gateway, input including selection of a user interface element to modify an aspect of the communication; and triggering, by the gateway, modification of the communication based on the input. In some embodiments, the modification of the communication can include blocking the communication.

According to yet another aspect of the concepts and technologies disclosed herein, a computer storage medium is disclosed. The computer storage medium can store computer-executable instructions that, when executed by a processor, cause the processor to perform operations. The operations can include detecting, at the gateway using an Internet-of-things hub, a communication associated with an Internet-of-things device. The communication can include an attempt for the Internet-of-things device to communicate with another device. The operations further can include determining, by the gateway and based on connection data included in security communications received from the Internet-of-things device, if the communication associated with the Internet-of-things device should be allowed. In response to a determination that the communication associated with the Internet-of-things device should not be allowed, the operations can include taking, by the gateway, an action to limit the communication. In response to a determination that the communication should be allowed, the operations can include allowing, by the gateway, the communication.

In some embodiments, the Internet-of-things device communicates with the gateway via an Internet-of-things network that can include the Internet-of-things device and the gateway. In some embodiments, the Internet-of-things device can be onboarded by the gateway by performing operations including detecting an onboarding request from the Internet-of-things device; prompting the Internet-of-things device to obtain a hardware verification; and in response to determining that the hardware verification is received, onboarding the Internet-of-things device. In some embodiments, the hardware verification can include detecting manipulation of a hardware device to generate an input at the Internet-of-things device.

In some embodiments, the hardware verification can include verifying that an output by the hardware device has been detected at the Internet-of-things device. In some embodiments, the computer-executable instructions, when executed by the processor, can cause the processor to perform operations further including generating, at the gateway, display data including renderable data for presenting a user interface that depicts the communication; receiving, at the gateway, input including selection of a user interface element to modify an aspect of the communication; and triggering, by the gateway, blocking of the communication based on the input.

Other systems, methods, and/or computer program products according to embodiments will be or become apparent to one with skill in the art upon review of the following drawings and detailed description. It is intended that all such additional systems, methods, and/or computer program products be included within this description, and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for device-level security management for Internet-of-things devices, according to an illustrative embodiment of the concepts and technologies described herein.

FIG. 3 is a flow diagram showing aspects of a method for onboarding an Internet-of-things device, according to an illustrative embodiment of the concepts and technologies described herein.

FIG. 4 is a flow diagram showing aspects of a method for gateway-level security management for an Internet-of-things device, according to an illustrative embodiment of the concepts and technologies described herein.

FIG. 5 is a flow diagram showing aspects of a method for user-level security management for Internet-of-things devices, according to an illustrative embodiment of the concepts and technologies described herein.

FIGS. 6A-6E are user interface diagrams showing various screen displays for use in providing security management for Internet-of-things devices, according to some illustrative embodiments of the concepts and technologies described herein.

FIG. 7 schematically illustrates a network, according to an illustrative embodiment of the concepts and technologies described herein.

FIG. 8 is a block diagram illustrating an example computer system configured to provide security management for Internet-of-things devices, according to some illustrative embodiments of the concepts and technologies described herein.

FIG. 9 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to security management for Internet-of-things devices. One or more Internet-of-things devices can communicate with each other and/or other devices via an Internet-of-things network. In some embodiments, the Internet-of-things network can include an Internet-of-things hub, which can be executed and/or hosted by a gateway. Thus, the Internet-of-things devices can communicate with each other, with the Internet-of-things hub, and/or with other devices or resources (e.g., a resource such as a website, application, or the like) via the gateway. One or more of the Internet-of-things devices can include a security application for managing security of the Internet-of-things devices and a hardware selector, which may be used during an onboarding process and/or at other times to verify that a user or other entity has requested a particular operation associated with the Internet-of-things device.

In some embodiments, one or more of the Internet-of-things devices can be installed with and/or infected with a malware. The malware may attempt to conduct communications via the Internet-of-things network and/or to infect other Internet-of-things devices or other devices on the Internet-of-things network or in a proximity of the Internet-of-things device on which the malware is operating. According to some embodiments, a gateway or other device can include an Internet-of-things hub. The Internet-of-things hub can be configured to provide hub-level security for the Internet-of-things network, for example by monitoring communications among and/or from the Internet-of-things devices to each other, the gateway, and/or external devices such as the resource. The Internet-of-things hub can be configured to exchange security communications with the Internet-of-things devices to onboard the Internet-of-things devices, to allow and/or block communications via the Internet-of-things hub, to obtain connection data associated with the Internet-of-things devices, and/or for other reasons.

The Internet-of-things hub can be configured to analyze communications occurring via the gateway and/or among devices on the Internet-of-things network to determine if communications are expected, unexpected, legitimate, malicious, or the like. Thus, the Internet-of-things hub can, based on analysis of the communications and/or via analysis of one or more connection policies, identify potentially compromised Internet-of-things devices (e.g., Internet-of-things devices that are running the malware). The Internet-of-things hub can also be configured to generate display data. The display data can be rendered by a device (e.g., a user device) to present a user interface for managing the communications and/or providing alerts and/or monitoring information, and/or can be used to generate a portal at the Internet-of-things hub that can be accessed by the user device.

The user interface or portal can be interacted with by the user device or other entities to manage communications and/or devices associated with the Internet-of-things network. In some embodiments, the user device can detect manipulations of the user interface and send input to the Internet-of-things hub for acting on the detected manipulations. Alternatively, the Internet-of-things hub can detect manipulations via the portal. The Internet-of-things hub can manage the security of the Internet-of-things network by, for example, blocking communications, enabling communications, blocking devices, enabling devices, onboarding devices, combinations thereof, or the like. In various embodiments, the Internet-of-things hub can obtain updates for the Internet-of-things hub and/or for the Internet-of-things devices. Thus, the updates can update the connection policies, the firmware of Internet-of-things devices, software of the Internet-of-things devices such as the security application, and/or send other changes to Internet-of-things devices such as security patches, device lists, combinations thereof, or the like.

A such, it can be appreciated that the concepts and technologies disclosed herein can provide device-level security management for Internet-of-things devices, hub-level security for Internet-of-things devices, and/or service-level security management for Internet-of-things devices. Namely, the Internet-of-things devices can include a security application that can provide some level of security management at the device level, the Internet-of-things hub can provide some level of security management at the hub-level, and the security management service can provide security management at the service level such as a cloud-based or server-based service for enhancing security management of Internet-of-things devices. It should be understood that these examples are illustrative, and therefore should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

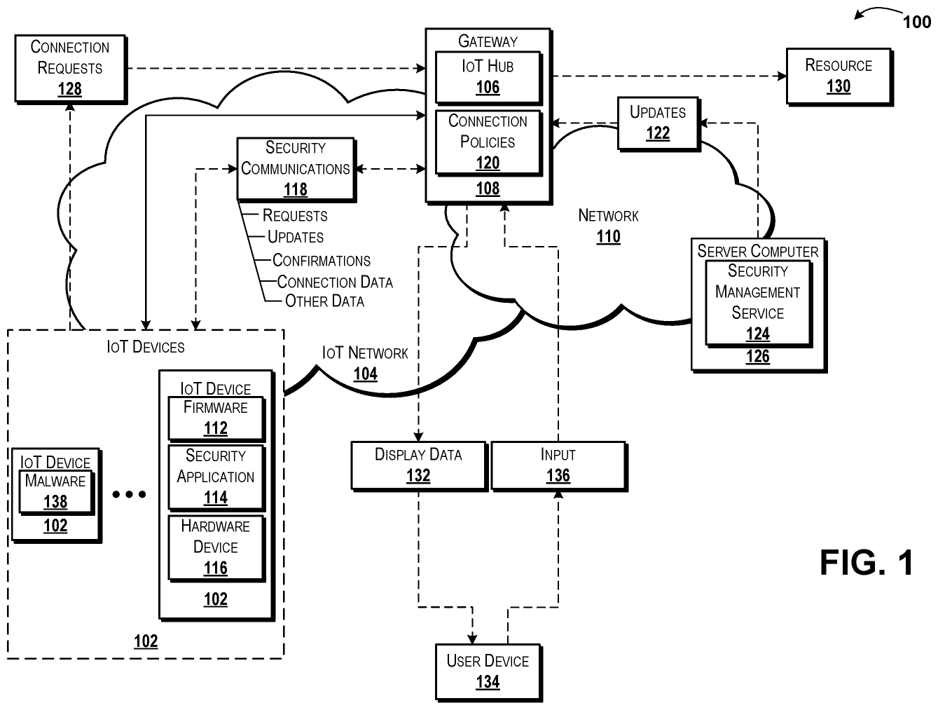

Referring now to FIG. 1, aspects of an operating environment 100 for various embodiments of the concepts and technologies disclosed herein for security management for Internet-of-things devices will be described, according to an illustrative embodiment. The operating environment 100 shown in FIG. 1 can include one or more Internet-of-things device 102 (labeled “IoT Devices 102” in FIG. 1). According to various embodiments of the concepts and technologies disclosed herein, the Internet-of-things devices 102 can operate in communication with and/or as part of an Internet-of-things network 104.

The Internet-of-things network 104 can be include one or more Internet-of-things devices 102 that can be within communication range of one another. In some embodiments, the Internet-of-things network 104 also can include an Internet-of-things hub 106 (labeled “IoT Hub 106” in FIG. 1). According to some embodiments of the concepts and technologies disclosed herein, the Internet-of-things hub 106 can correspond to an application, module, or service executing on a computing device such as, for example, a gateway 108 or other computing device, and therefore can be a part of or in communication with the Internet-of-things network 104.

In some other embodiments, the Internet-of-things hub 106 can correspond to an application, module, or service executing on a communications network (hereinafter “network”) 110, and therefore the functionality of the gateway 108 may be provided, in some embodiments, by an application server or other device that can operate on the network 110. For purposes of describing the concepts and technologies disclosed herein, the Internet-of-things hub 106 is described herein in accordance with an embodiment in which the Internet-of-things hub is hosted by the gateway 108. The gateway 108 can be located, in various embodiments, in proximity to (e.g., within a communication range of) the Internet-of-things devices 102. As such, the gateway 108 can operate as a part of the Internet-of-things network 104 in various embodiments including the illustrated embodiment. Based on the above, it should be understood that this illustrated and described example embodiment is illustrative, and therefore should not be construed as being limiting in any way.

According to various embodiments, the functionality of the gateway 108 may be provided by one or more server computers, desktop computers, connected home devices, gateway devices, and/or other computing systems, and the like. It should be understood that the functionality of the device that hosts the Internet-of-things hub 106 may be provided by a single device, by two or more similar devices, and/or by two or more dissimilar devices. For purposes of describing the concepts and technologies disclosed herein, the gateway 108 is described herein as a connected home gateway device. It should be understood that this embodiment is illustrative, and should not be construed as being limiting in any way.

According to various embodiments of the concepts and technologies disclosed herein, one or more of the Internet-of-things devices 102 can execute an operating system or firmware (hereinafter “firmware”) 112 and one or more application programs such as, for example, a security application 114. The firmware 112 can include a computer program or routine for controlling the operation of the Internet-of-things device 102. The security application 114 can include an executable program or routine that can be configured to execute on top of the firmware 112 to provide various functions as illustrated and described herein. One or more of the Internet-of-things devices 102 also can include a hardware device 116 such as a selector, light, speaker, or other input or output device. The hardware device 116 and the functionality thereof will be explained in more detail below.

The security application 114 can be configured to monitor communications and/or connections associated with the Internet-of-things device 102 on which the security application 114 is executing. According to various embodiments of the concepts and technologies disclosed herein, the security application 114 can monitor outgoing communications and/or connection requests of the Internet-of-things device 102, incoming communications and/or connection requests received by the Internet-of-things device 102, and various aspects of these and other communications and/or connections such as, for example, destination devices communicated with, source devices communicated with, endpoints of connections associated with the Internet-of-things device 102, content sent and/or received during the communications and/or connections, connection and/or communication logs associated with the Internet-of-things device 102, combinations thereof, or the like.

In some embodiments of the concepts and technologies disclosed herein, the Internet-of-things device 102 can communicate with one another using peer-to-peer communications. The security application 114 can be configured to monitor these peer-to-peer communications and to create logs of the peer-to-peer communications (in addition to other types of communications, which also can be monitored and/or logged by the security application 114). Additionally, the security application 114 can be configured to detect unexpected communications with or from other devices. Unexpected communications can include communications to or from devices that are not expected to communicate with the Internet-of-things device 102; a volume of communications that exceeds what would be expected to or from a device; content in communications that would not be expected; frequency of communications that are unexpected; combinations thereof; or the like. The Internet-of-things devices 102 can report such communications to each other, in some embodiments. As such, the Internet-of-things devices 102 can inform one another of threats, thereby enabling Internet-of-things devices 102 to avoid such threats and/or to take other actions with respect to such threats.

In some other embodiments, the Internet-of-things devices 102 can be configured to report suspicious communications to the Internet-of-things hub 106. Thus, multiple self-reporting Internet-of-things devices 102 can function as a crowd-sourced communication reporting network, and the Internet-of-things hub 106 can perform operations to mitigate any risks posed by the communications, as will be explained in more detail herein. It should be understood that this example is illustrative, and therefore should not be construed as being limiting in any way.

Thus, it can be appreciated that the security application 114 can be configured to track any communications or connections associated with the Internet-of-things device 102 and/or the contents and/or endpoints associated with any of the communications and/or connections. The security application 114 also can be configured to control detected communications and/or connections. For example, in some embodiments, the security application 114 can be configured to block communications, modify the types and/or categories of data (e.g., video data, audio data, text, images, etc.) that can and/or cannot be sent (in general and/or to specific devices), modify the types of data (e.g., video data, audio data, text, images, etc.) that can and/or cannot be received (in general and/or from specific devices), limit the creation of new connections, and/or take other actions to control the creation and/or use of various connections. Because other aspects of connections and/or communications can be monitored and/or controlled by the security application 114, it should be understood that the above examples are illustrative, and therefore should not be construed as being limiting in any way.

According to various embodiments of the concepts and technologies disclosed herein, the security application 114 also can be configured to communicate with the Internet-of-things hub 106 regarding the monitored communications and/or connections. In particular, the security application 114 can be configured to exchange security communications 118 with the Internet-of-things hub 106. The security communications can include, but are not limited to, requests, updates, confirmations, connection data, and/or other data, each of which is explained in more detail herein.

The requests can include onboarding requests, update requests, informational requests, other requests, combinations thereof, or the like. During onboarding of the Internet-of-things device 102 with the gateway 108 and/or other entities on the Internet-of-things network 104, the Internet-of-things hub 106 can be configured to generate an onboarding request. This onboarding request can inform the Internet-of-things device 102 to respond with an onboarding input or confirmation of onboarding output, for example an indication that the hardware device 116, which can include, for example, a switch, has been manipulated by a user or other entity; a confirmation that a light or sound output has been detected by a user or other entity; other input; other output; combinations thereof; or the like. The hardware device 116 can correspond, in various embodiments, to a button, a switch, or another selector; to a bulb, a light-emitting diode (“LED”), or another lighting device; to a speaker, a siren, or another audio output device; other visual output devices such as a display or readout; combinations thereof; or the like.

At various times such as, for example, during the onboarding of the Internet-of-things device 102 to communicate with the Internet-of-things hub 106 and/or other devices on the Internet-of-things network 104, a user or other entity may be requested or required to manipulate the hardware device 116 or to confirm output from the hardware device 116 to demonstrate that the onboarding is occurring with the approval of the user or other entity. In some embodiments, any onboarding request that is not verified by physical confirmation such as manipulation of a button or switch, confirmation of beeps or other audio output, confirmation of text output, confirmation of light output, and/or confirmation of other input/output, may be denied by the Internet-of-things hub 106. It should be understood that this example is illustrative, and therefore should not be construed as being limiting in any way.

In one contemplated embodiment, the hardware device 116 can correspond to a button that, when selected, can cause the Internet-of-things device 102 to send a signal to the Internet-of-things hub 106 (e.g., as part of the security communications 118), which when received by the Internet-of-things hub 106 can cause the Internet-of-things hub 106 to allow the Internet-of-things device 102 to be onboarded to the Internet-of-things network 104. In another contemplated embodiment, the hardware device 116 can correspond to an LED or speaker that can output light or sound. During onboarding of the Internet-of-things device 102, a user or other entity may be required to confirm the light or sound output (or such output may be confirmed by the gateway 108 or other device with audio or visual capability) and, when confirmation is made or received by the Internet-of-things hub 106, the Internet-of-things hub 106 may allow the Internet-of-things device 102 to be onboarded to the Internet-of-things network 104. It should be understood that these examples are illustrative, and therefore should not be construed as being limiting in any way.

The requests also can include update requests, which can be generated by the Internet-of-things device 102 or the Internet-of-things hub 106 (or other devices or entities). The update requests can be generated by the Internet-of-things hub 106 or other entity and can instruct the Internet-of-things device 102 to update a firmware 112 or to obtain and/or install other security patches, in some embodiments. In some other embodiments, the update requests can be generated by the Internet-of-things device 102 and can request the Internet-of-things hub 106 or other entity to obtain an update (e.g., one of the updates 122) to update the firmware 112 of the Internet-of-things device 102 and/or to obtain other updates such as security patches. It should be understood that these examples are illustrative, and therefore should not be construed as being limiting in any way.

The informational requests can request information from the Internet-of-things device 102 such as, for example, connection logs, inbound connection information, outbound connection information, data transmission logs, combinations thereof, or the like. In some embodiments, the Internet-of-things hub 106 can request these and/or other information from the Internet-of-things device 102 and/or can obtain the information via the security communications 118. Because this and other information can be obtained by the Internet-of-things hub 106 in additional and/or alternative manners, it should be understood that these examples are illustrative, and therefore should not be construed as being limiting in any way.

The updates can include, for example, firmware updates, software updates (e.g., new versions or updates to the security application 114), permitted and/or blocked device lists, combinations thereof, or the like. The updates also can include security patches or other information. Because other types of updates are possible and are contemplated, it should be understood that these examples are illustrative, and therefore should not be construed as being limiting in any way. The confirmations can include, for example, confirmations associated with the hardware device 116 (e.g., a confirmation that the hardware device 116 has been manipulated at the Internet-of-things device 102), communication confirmations (e.g., confirmation of receipt of certain requests or other data transmissions), combinations thereof, or the like. Because other types of confirmations can be sent to and/or by the Internet-of-things device 102 and/or the Internet-of-things hub 106, it should be understood that these examples are illustrative, and therefore should not be construed as being limiting in any way.

The connection data can include, for example, information about connections detected by, received by, and/or made by the Internet-of-things device 102. The connection data therefore can include, for example, information about any connection by which information and/or communications are sent by, received by, and/or otherwise detected by the Internet-of-things device 102. The connection data can include time information (e.g., time and date of the communication or connection, duration of the communication or connection, and the like), endpoint information (e.g., a destination device, a source device, and the like), content information (e.g., data in the communication or connection, data types in the communication or connection, size of the data in the communication or connection, or the like), and/or other information that can describe the connections and/or communications. Because other information associated with the communications is possible and is contemplated, it should be understood that these examples are illustrative, and therefore should not be construed as being limiting in any way. The other data can include other information illustrated and described herein as being communicated to, from, and/or between the Internet-of-things device 102 and other devices or entities such as, for example, other Internet-of-things devices 102, the gateway 108, the resource 130, or other entities.

The Internet-of-things hub 106 also can access one or more connection policies 120. Although the connection policies 120 are illustrated in FIG. 1 as being stored at the gateway 108, it should be understood that this is only one illustrative embodiment. In particular, the connection policies 120 can be stored at other devices and/or resources and can be accessed by the Internet-of-things hub 106. The connection policies 120 can define, for a particular device or type of device (e.g., a particular Internet-of-things device 102 and/or a particular type of Internet-of-things device 102), one or more policies governing connections. The connection policies 120 can define, for example, types of connections that are allowed and/or not allowed for a particular Internet-of-things device 102 and/or type of Internet-of-things device 102; devices with which a particular Internet-of-things device 102 and/or type of Internet-of-things device 102 can and/or cannot communicate; data and/or types of data that can and/or cannot be transmitted by a particular Internet-of-things device 102 and/or type of Internet-of-things device 102; data and/or types of data that can and/or cannot be received by a particular Internet-of-things device 102 and/or type of Internet-of-things device 102; how new connections can and/or cannot be created by a particular Internet-of-things device 102 and/or type of Internet-of-things device 102; combinations thereof; or the like.

By way of example, a connection policy 120 may indicate that a particular type of device such as, for example, a dishwasher, can be expected to communicate with a water heater. The connection policy 120 may, however, indicate that the dishwasher would not be expected to communicate with a coffee machine. It should be understood that this example is illustrative, and therefore should not be construed as being limiting in any way. Thus, it can be appreciated that the connection policies 120 can help define what is “expected,” “unexpected,” or the like with regard to connections. According to various embodiments of the concepts and technologies disclosed herein, the Internet-of-things hub 106 can access the connection policies 120 and can send, to the Internet-of-things device 102 and/or other devices, connection data that can enable or disable certain connections and/or control the data that can and/or cannot be transmitted in association with a particular connection.

According to various embodiments of the concepts and technologies disclosed herein, the connection policies 120 can be updated at various times by various entities. In some embodiments, for example, the Internet-of-things hub 106 can receive one or more updates 122, and the connection policies 120 can be updated based on information included in the updates 122. The updates 122 can be received, in some embodiments, from a security management service 124 or other application, module, and/or service. An update 122 may, for example, update a connection policy 120 to address a new detected behavior (e.g., a coffee grinder communicating with a connected car) and to take some action. For example, the update 122 may update a connection policy 120 to block connections between certain devices, to limit the types of connections that can be made, combinations thereof, or the like.

According to various embodiments of the concepts and technologies disclosed herein, the security management service 124 can correspond to a cloud-based or server-based application or service for obtaining and/or sharing information about security for Internet-of-things devices 102. Thus, for example, the security management service 124 can obtain information from security sources, from device manufacturers, from users, and/or other entities, where such information can relate to security issues associated with Internet-of-things devices 102. The information can include, for example, lists of connections and/or types of connections that are expected and/or unexpected, information relating to how malware may propagate through an Internet-of-things network 104, combinations thereof, or the like. The security management service 124 can operate as a callable service (e.g., called by the Internet-of-things hub 106) and/or may push updates 122 to the Internet-of-things hub 106 without any requests or service calls being made. It should be understood that these examples are illustrative, and therefore should not be construed as being limiting in any way.

In the embodiment shown in FIG. 1, the security management service 124 is illustrated as being hosted by server computer 126 or other device. The functionality of the server computer 126 can be provided by an application server, a web server, a server computer, or the like. For purposes of illustrating and describing the concepts and technologies disclosed herein, the server computer 126 is described herein as a server computer 126. It should be understood that this example is illustrative, and therefore should not be construed as being limiting in any way.

According to various embodiments of the concepts and technologies disclosed herein, Internet-of-things devices 102 may be configured to access an external network such as the network 110, where “external network” can be used to refer to any network that is not a part of the Internet-of-things network 104. Such communications can be enabled, for example, via connections via the Internet-of-things hub 106 and/or other functionality associated with the gateway 108. In some embodiments, for example the embodiment shown in FIG. 1, the Internet-of-things device 102 can generate a connection request 128. The connection request 128 can be sent by the Internet-of-things device 102 to the gateway 108. It should be appreciated that the connection request 128 also can be included in the security communications 118 in some embodiments. The connection request 128 can request a connection between the Internet-of-things device 102 and a resource 130 such as an application, a data storage device, or the like. It should be understood that this example is illustrative, and therefore should not be construed as being limiting in any way.

The Internet-of-things hub 106 can be configured to examine the connection request 128 and to determine, based optionally on one or more of the connection request 128 or one or more of the connection policies 120, if the Internet-of-things device 102 should be allowed to connect to the resource 130. The connection request 128 may be allowed, for example, if one or relevant connection policies 120 indicate that the Internet-of-things device 102 should be allowed to connect with the resource 130 and/or that the connection is “expected.” Alternatively, the connection request 128 may be blocked, for example, if one or relevant connection policies 120 indicate that the Internet-of-things device 102 should not be allowed to connect with the resource 130 and/or that the connection is “unexpected.” Because the connection requests can be handled by the Internet-of-things hub 106 in additional and/or alternative manners, it should be understood that these examples are illustrative, and therefore should not be construed as being limiting in any way.

According to various embodiments of the concepts and technologies disclosed herein, the Internet-of-things hub 106 also can be configured to report activity associated with the Internet-of-things network 104 to one or more entities. In various embodiments, the Internet-of-things hub 106 can be configured to generate display data 132 and/or to enable a portal via which information associated with the Internet-of-things network 104 can be viewed and/or interacted with by a user or entity, for example using a user device 134. According to various embodiments of the concepts and technologies disclosed herein, the functionality of the user device 134 can be provided by a mobile phone, a smartphone, a laptop computer, a tablet computer, a desktop computer, a set-top box, other computing devices, combinations thereof, or the like.

According to various embodiments of the concepts and technologies disclosed herein, the user device 134 can interact with a UI or portal, which can be generated by the Internet-of-things hub 106 and/or generated by the user device 134 using the display data 132. The user device 134 or a device hosting the portal can obtain, from the user device 134, input 136. The input 136 can correspond to selections and/or input such as, for example, selection of options to view information associated with the Internet-of-things network 104, selection of options to view connections associated with the Internet-of-things devices 102, selection of options to block communications, selection of options to onboard Internet-of-things devices 102, and/or other types of input, which can be entered at the user device 134 and/or via a portal or other functionality. The input 136 can be obtained by the Internet-of-things hub 106 and used to alter communications associated with one or more of the Internet-of-things devices 102.

Although the display data 132 and the input 136 are illustrated as traversing at least part of the Internet-of-things network 104 and/or the network 110, it should be understood that according to various embodiments of the concepts and technologies disclosed herein, the display data 132 and/or the input 136 can be communicated to the user device 134 via direct connections, via other networks or peer-to-peer communications, by one of the Internet-of-things network 104 or the network 110, and/or without the use of the Internet-of-things network 104 or the network 110. As such, the illustrated embodiment should be understood as being illustrative and should not be construed as being limiting in any way. These and other aspects of the concepts and technologies disclosed herein for security management of Internet-of-things devices 102 will be illustrated and described in more detail below.

In some embodiments, one or more of the Internet-of-things devices 102 can host or otherwise execute a malicious program, routine, or other form of software or software code (“malware”) 138. In some embodiments, the malware 138 may be included in the Internet-of-things device 102 when manufactured and/or shipped by a manufacturer. In some other embodiments, the Internet-of-things device 102 may be infected by or otherwise install the malware 138. In some embodiments, for example, an Internet-of-things device 102 may have a simple kernel (e.g., a LINUX kernel) or other firmware 112 that can, in some embodiments, be taken control of easily by some hackers or malicious programs.

Thus, an Internet-of-things device 102 may be configured by the malware 138 to propagate the malware 138 to other Internet-of-things devices 102 and/or to perform other malicious operations such as, for example, obtaining video, audio, and/or images without authorization, instructing other Internet-of-things devices 102 to perform unrequested operations (e.g., to turn on noisy appliances at strange times), and/or to perform other operations to harass users or other entities, and/or for other purposes such as obtaining confidential information. Because the malware 138 can be propagated in other ways and/or used for other purposes, it should be understood that these examples are illustrative, and therefore should not be construed as being limiting in any way.

In practice, one or more Internet-of-things devices 102 can communicate with each other and/or with other devices via an Internet-of-things network 104. In some embodiments, the Internet-of-things network 104 can include an Internet-of-things hub 106, which can be executed and/or hosted by a gateway 108 or other device. Thus, the Internet-of-things devices 102 can communicate with each other, with the Internet-of-things hub 106, and/or with other devices or resources (e.g., a resource 130 such as a website, application, or the like) via the gateway 108. One or more of the Internet-of-things devices 102 can include a security application 114 for managing security of the Internet-of-things devices 102 and a hardware device 116, which may be used during an onboarding process and/or at other times to verify that a user or other entity has requested a particular operation.

In some embodiments, one or more of the Internet-of-things devices 102 can be installed with and/or infected with a malware 138. The malware 138 may attempt to conduct communications via the Internet-of-things network 104 and/or to infect other Internet-of-things devices 102 or other devices on the Internet-of-things network 104. It should be understood that this example is illustrative, and therefore should not be construed as being limiting in any way. According to some embodiments, a gateway or other device such as the gateway 108 can include an Internet-of-things hub 106, which can provide hub-level security for the Internet-of-things network 104, for example by monitoring communications to, among, and/or from the Internet-of-things devices 102 to each other, the gateway 108, and/or external devices such as the resource 130. The Internet-of-things hub 106 can be configured to exchange security communications 118 with the Internet-of-things devices 102 to onboard the Internet-of-things devices 102, to allow and/or block communications via the Internet-of-things hub 106, to obtain connection data associated with the Internet-of-things devices 102, and/or for other reasons.

The Internet-of-things hub 106 can be configured to analyze communications occurring via the gateway 108 and/or among devices on the Internet-of-things network 104 to determine if communications are expected, unexpected, legitimate, malicious, or the like. Thus, the Internet-of-things hub 106 can, based on analysis of the communications and/or via analysis of one or more connection policies 120, identify potentially compromised Internet-of-things devices 102 (e.g., Internet-of-things devices 102 that are running the malware 138). The Internet-of-things hub 106 can also be configured to generate display data 132. The display data 132 can be rendered by a device (e.g., the user device 134) to present a user interface for managing the communications, in some embodiments, or used to generate a portal at the Internet-of-things hub 106 that can be accessed by the user device 134.

The user interface or portal can be interacted with by the user device 134 or other entities to manage communications and/or devices associated with the Internet-of-things network 104. In some embodiments, the user device 134 can detect manipulations of the user interface and send input 136 to the Internet-of-things hub 106 for acting on the detected manipulations. Alternatively, the Internet-of-things hub 106 can detect manipulations via the portal. The Internet-of-things hub 106 can manage the security of the Internet-of-things network 104 by, for example, blocking communications, enabling communications, blocking devices, enabling devices, onboarding devices, combinations thereof, or the like. In various embodiments, the Internet-of-things hub 106 can obtain updates 122 for the Internet-of-things hub 106 and/or for the Internet-of-things devices 102. Thus, the updates 122 can update the connection policies, the firmware 112 of Internet-of-things devices 102, software of the Internet-of-things devices 102 such as the security application 114, and/or send other changes to Internet-of-things devices 102 such as security patches, device lists, combinations thereof, or the like.

A such, it can be appreciated that the concepts and technologies disclosed herein can provide device-level security management for Internet-of-things devices 102, hub-level security for Internet-of-things devices 102, and/or service-level security management for Internet-of-things devices 102. Namely, the Internet-of-things devices 102 can include a security application 114 that can provide some level of security management at the device level, the Internet-of-things hub 106 can provide some level of security management at the hub-level, and the security management service 124 can provide security management at the service level such as a cloud-based or server-based service for enhancing security management of Internet-of-things devices 102. It should be understood that these examples are illustrative, and therefore should not be construed as being limiting in any way.

According to various embodiments of the concepts and technologies disclosed herein, the Internet-of-things network 104 can be managed by users or other entities (or the Internet-of-things hub 106) as a social network and therefore may be referred to herein as an Internet-of-things social network. In particular, a user, other entity, or the Internet-of-things hub 106 can be enabled, by the concepts and technologies disclosed herein, to moderate and/or otherwise control communications among, by, and between the Internet-of-things devices 102 and other devices on or outside of the Internet-of-things network 104. An authorized entity such as a homeowner or the Internet-of-things hub 106 can be empowered to remove Internet-of-things devices 102 on demand, to limit communications of the Internet-of-things devices 102 on demand, to isolate (from the Internet-of-things network 104) the Internet-of-things devices 102 on demand, and/or otherwise to control the Internet-of-things network 104 and/or the Internet-of-things devices 102. It should be understood that this example is illustrative, and therefore should not be construed as being limiting in any way.

FIG. 1 illustrates two Internet-of-things devices 102, one Internet-of-things network 104, one gateway 108, one network 110, one resource 130, and one user device 134. It should be understood, however, that various implementations of the operating environment 100 can include one or more than one Internet-of-things device 102; one or more than one Internet-of-things network 104; zero, one, or more than one gateway 108, zero, one, or more than one network 110; zero, one, or more than one resource 130; and/or zero, one, or more than one user device 134. As such, the illustrated embodiment should be understood as being illustrative, and should not be construed as being limiting in any way.

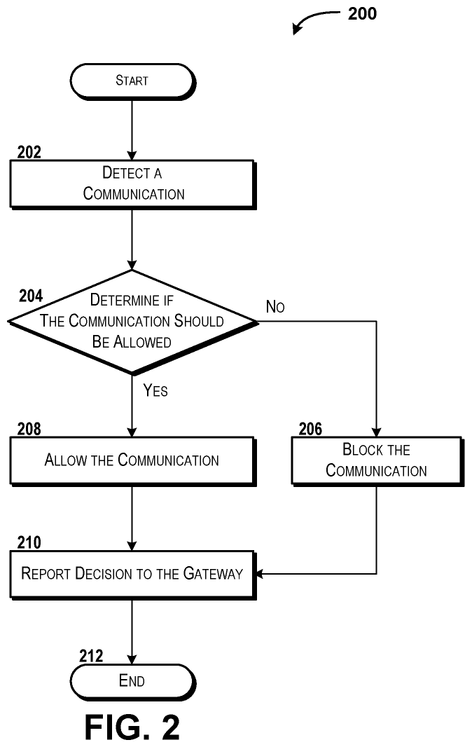

Turning now to FIG. 2, aspects of a method 200 for device-level security management for Internet-of-things devices 102 will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the Internet-of-things device 102, the gateway 108, the server computer 126, and/or the user device 134, to perform one or more operations and/or causing the processor to direct other components of the computing system or device to perform one or more of the operations.

For purposes of illustrating and describing the concepts of the present disclosure, the method 200 is described herein as being performed by the Internet-of-things device 102 via execution of one or more software modules such as, for example, the security application 114. It should be understood that additional and/or alternative devices and/or network nodes can provide the functionality described herein via execution of one or more modules, applications, and/or other software including, but not limited to, the security application 114. Thus, the illustrated embodiments are illustrative, and should not be viewed as being limiting in any way.

The method 200 begins at operation 202. At operation 202, the Internet-of-things device 102 can detect an attempted communication and/or connection. In particular, operation 202 can correspond to the Internet-of-things device 102 detecting a communication (or attempted communication or connection) from another device such as, for example, another Internet-of-things device 102. In some embodiments, this Internet-of-things device 102 to Internet-of-things device 102 communication can correspond to a request to communicate.

Thus, it should be understood that the communication detected in operation 202 can correspond to an incoming communication or communication request (e.g., a first Internet-of-things device 102 sending or attempting to send data to a second Internet-of-things device 102), an outgoing communication or communication request (e.g., an Internet-of-things device 102 may detect an attempt to connect to another device), or other communications. These communications can be detected, in some embodiments, by the security application 114 and/or other functionality at the Internet-of-things device 102.

In some contemplated embodiments, the communication or attempted communication detected in operation 202 can be initiated by another Internet-of-things device 102 that may be infected with and/or otherwise executing a malware 138. Because other communications can be detected in various embodiments of the concepts and technologies disclosed herein, the above examples should be understood as being illustrative, and therefore should not be construed as being limiting in any way.

From operation 202, the method 200 can proceed to operation 204. At operation 204, the Internet-of-things device 102 can determine if the communication detected in operation 202 should be allowed. In some embodiments, the Internet-of-things device 102 can determine if the communication detected in operation 202 should be blocked. The Internet-of-things device 102 can make the determination of operation 204, in some embodiments, by execution of the security application 114 and/or based on other information (e.g., provided to the Internet-of-things device 102 via security communications 118, installed on the Internet-of-things device 102, or otherwise available to the Internet-of-things device 102).

In some embodiments, for example, the Internet-of-things device 102 can detect the communications and determine, based on rules, libraries, policies, or other considerations, if the communication is legitimate, malicious, expected, or unexpected; whether the source of the communication is legitimate, malicious, expected, or unexpected; whether the contents of the communication are legitimate, malicious, expected, or unexpected; and/or if the destination of the communication is expected or unexpected. Based on these and/or other considerations as illustrated and described herein, the Internet-of-things device 102 can determine whether the communication detected in operation 202 should be allowed, blocked, or otherwise limited.

If the Internet-of-things device 102 determines, in operation 204, that the communication detected in operation 202 should not be allowed (or that the communication should be blocked or otherwise limited), the method 200 can proceed to operation 206. At operation 206, the Internet-of-things device 102 can block the communication or attempted connection detected in operation 202, impose limits on some aspect of the communication detected in operation 202, or otherwise interrupt the communication detected in operation 202 and/or future communications similar to the communication detected in operation 202.

For example, if the communication detected in operation 202 came from an unexpected source, the Internet-of-things device 102 can block future communications from that unexpected source. In another embodiments, if the communication detected in operation 202 included unexpected contents, the Internet-of-things device 102 can block future communications that attempt to deliver contents similar to the unexpected contents in the communication detected in operation 202. In another embodiment, if the communication detected in operation 202 was directed (by the Internet-of-things device 102) to an unexpected or unauthorized recipient, the Internet-of-things device 102 can block future communications to that recipient. Because other limits can be imposed on the communications as illustrated and described herein, it should be understood that these examples are illustrative, and therefore should not be construed as being limiting in any way.

If the Internet-of-things device 102 determines, in operation 204, that the communication detected in operation 202 should be allowed (or that the communication should not be blocked or otherwise limited), the method 200 can proceed to operation 208. At operation 208, the Internet-of-things device 102 can allow the communication or attempted connection detected in operation 202 and/or allow future communications similar to the communication detected in operation 202. Thus, for example, the Internet-of-things device 102 can allow communications from certain devices, to certain devices, with certain content, combinations thereof, or the like.

From operation 208, the method 200 can proceed to operation 210. The method 200 also can proceed to operation 210 from operation 206. At operation 210, the Internet-of-things device 102 can report the decision made in operation 204 to the gateway 108. Thus, operation 210 can include the Internet-of-things device 102 generating a report (e.g., a communication including connection data) and sending a security communication 118 that includes the report to the gateway 108. Because the decision can be reported by the Internet-of-things device 102 in additional and/or alternative manners, it should be understood that this example is illustrative, and therefore should not be construed as being limiting in any way.

Although the method 200 has been described as being performed by the Internet-of-things device 102, it should be understood that the gateway 108 also can be configured to perform a method for controlling communications at, by, and/or between the Internet-of-things devices 102. In particular, the gateway 108 can be configured to detect a communication to or from a first Internet-of-things device 102 to a second Internet-of-things device 102. The gateway 108 can detect the communication based on security communications 108 provided by one or more of the Internet-of-things devices 102 and/or based on the communications occurring via the gateway 108. The gateway 108 can then perform operations that can be substantially similar to operations 204-208, where the gateway 108 can determine if the communication should be allowed, blocked, limited, or the like. It should be understood that this example is illustrative, and therefore should not be construed as being limiting in any way.

From operation 210, the method 200 can proceed to operation 212. The method 200 can end at operation 212.

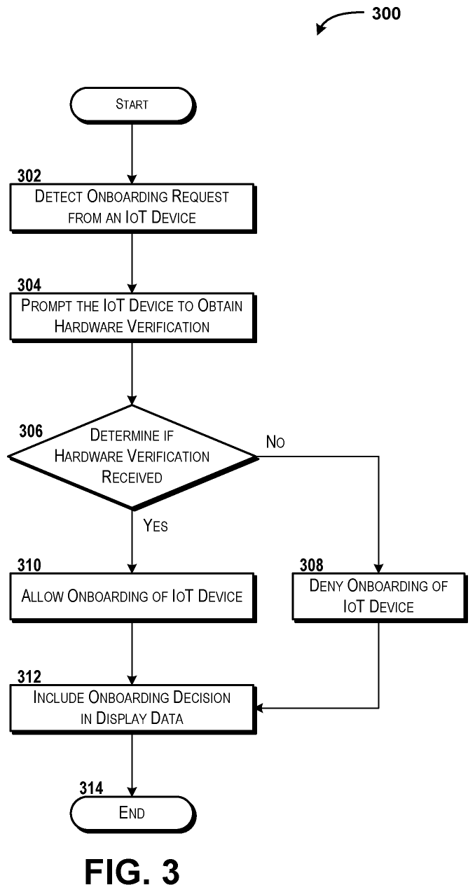

Turning now to FIG. 3, aspects of a method 300 for onboarding an Internet-of-things device 102 will be described in detail, according to an illustrative embodiment. For purposes of illustrating and describing the concepts of the present disclosure, the method 300 is described herein as being performed by the gateway 108 via execution of one or more software modules such as, for example, the Internet-of-things hub 106. It should be understood that additional and/or alternative devices and/or network nodes can provide the functionality described herein via execution of one or more modules, applications, and/or other software including, but not limited to, the Internet-of-things hub 106. Thus, the illustrated embodiments are illustrative, and should not be viewed as being limiting in any way.

The method 300 begins at operation 302. At operation 302, the gateway 108 can detect an onboarding request from an Internet-of-things device 102. The onboarding request can be detected, in some embodiments, by the gateway 108 based on a security communication 118, which as explained above can include an onboarding request. The onboarding request can request that the gateway 108 allow the Internet-of-things device 102 to join the Internet-of-things network 104 and/or to communicate outside of the Internet-of-things network 104 via the gateway 108. Because other types of communications can be enabled by way of the onboarding an Internet-of-things device 102, it should be understood that other types of communications can be requested by way of the onboarding request.

From operation 302, the method 300 can proceed to operation 304. At operation 304, the gateway 108 can prompt the Internet-of-things device 102 to obtain a hardware verification. As explained above, the hardware verification can be requested by way of the security communications 118. Also, as noted above, the hardware verification can request a particular type of input (e.g., pushing a button, manipulating a switch, pulling a button, etc.) or request verification of a particular type of output (e.g., verifying sounds, verifying text, verifying light, etc.). According to various embodiments of the concepts and technologies disclosed herein, the requested hardware verification can be confirmed or made via the hardware device 116 illustrated and described herein. It should be understood that this example is illustrative, and therefore should not be construed as being limiting in any way.

From operation 304, the method 300 can proceed to operation 306. At operation 306, the gateway 108 can determine if the hardware verification has been received. As noted above, the hardware verification can be made via the security communications 118, where the security communications 118 can include a verification that certain output occurred at the Internet-of-things device 102, a verification that certain input was detected at the Internet-of-things device 102, and/or other forms of verification as illustrated and described herein. Thus, operation 306 can correspond to the gateway 108 determining if any data or signal that can indicate that the hardware verification has been received. It should be understood that this example is illustrative, and therefore should not be construed as being limiting in any way.

If the gateway 108 determines, in operation 306, that the hardware verification requested in operation 304 has not been received, the method 300 can proceed to operation 308. At operation 308, the gateway 108 can block or deny the onboarding of the Internet-of-things device 102 as requested in the onboarding request detected in operation 302. If the gateway 108 determines, in operation 306, that the hardware verification has been received, the method 300 can proceed to operation 310.

At operation 310, the gateway 108 can allow onboarding of the Internet-of-things device 102. Thus, the gateway 108 can enable communications via the gateway 108 and/or inform other Internet-of-things devices 102 on the Internet-of-things network 104 that they are allowed to communicate with the newly-onboarded Internet-of-things device 102. Because onboarding of the Internet-of-things device 102 can include additional and/or alternative operations (e.g., sharing authentication keys or codes, controlling frequencies, etc.), it should be understood that these examples are illustrative, and therefore should not be construed as being limiting in any way.

From operation 310, the method 300 can proceed to operation 312. The method 300 also can proceed to operation 312 from operation 308. At operation 312, the gateway 108 can include the onboarding decision in display data 132. At operation 312, the gateway 108 can generate display data 132 that indicates onboarding of the Internet-of-things device 102 for providing to a user or other entity via a portal, user interface, or the like. As explained above, a user or other entity can view the display data 132 and act on the data as illustrated and described herein. Thus, although not shown separately in FIG. 3, the display data 132 can be provided to the user device 134 or made accessible to the user device 134 for additional operations as illustrated and described herein.

From operation 312, the method 300 can proceed to operation 314. The method 300 can end at operation 314.

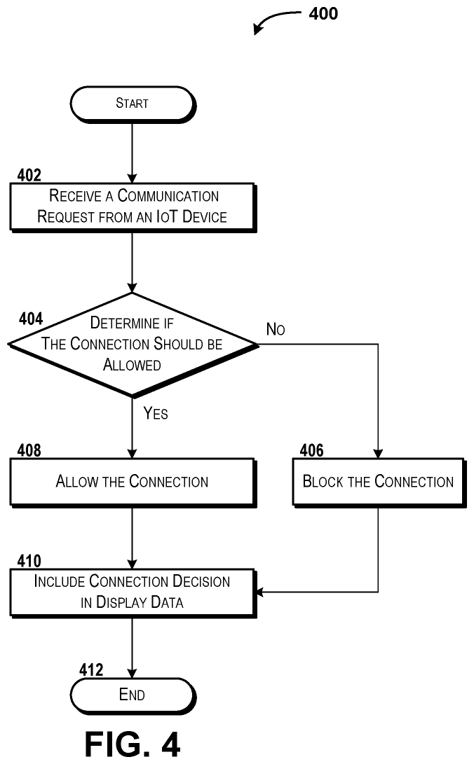

Turning now to FIG. 4, aspects of a method 400 for gateway-level security management for an Internet-of-things device 102 will be described in detail, according to an illustrative embodiment. For purposes of illustrating and describing the concepts of the present disclosure, the method 400 is described herein as being performed by the gateway 108 via execution of one or more software modules such as, for example, the Internet-of-things hub 106. It should be understood that additional and/or alternative devices and/or network nodes can provide the functionality described herein via execution of one or more modules, applications, and/or other software including, but not limited to, the Internet-of-things hub 106. Thus, the illustrated embodiments are illustrative, and should not be viewed as being limiting in any way.

The method 400 begins at operation 402. At operation 402, the gateway 108 can receive a connection request 128 from an Internet-of-things device 102. According to various embodiments of the concepts and technologies disclosed herein, the connection request 128 received in operation 402 can correspond to an Internet-of-things device 102 attempting to connect, via the gateway 108, with an external (e.g., not on the Internet-of-things network 104) resource 130 such as, for example, an application, website, data repository, combinations thereof, or the like.

It therefore should be understood that the connection request 128 can correspond to an attempt to access the resource 130, and not to an explicit request to establish a connection. In some other embodiments, the connection request 128 can correspond to an explicit request for the gateway 108 to establish a connection or communication channel between the Internet-of-things device 102 and the resource 130. Because communications can be requested in additional and/or alternative manners, it should be understood that these examples are illustrative, and therefore should not be construed as being limiting in any way.

From operation 402, the method 400 can proceed to operation 404. At operation 404, the gateway 108 can determine if the communication associated with the connection request 128 received in operation 402 should be allowed, not allowed, blocked, and/or not blocked. It can be appreciated that in some embodiments, the gateway 108 can determine, in operation 404, if the communication associated with the connection request 128 received in operation 402 should be blocked, not allowed, or not blocked; of the communication channel requested in operation 404 should be established or not; or the like.

If the gateway 108 determines, in operation 404, that the communication associated with the connection request 128 received in operation 402 should not be allowed and/or should be blocked, the method 400 can proceed to operation 406. At operation 406, the gateway 108 can block the connection requested in operation 402 and/or deny establishment of the communication channel requested in operation 402.

If the gateway 108 determines, in operation 404, that the communication associated with the connection request 128 received in operation 402 should be allowed, the method 400 can proceed to operation 408. At operation 408, the gateway 108 can allow the connection requested in operation 402 and/or allow establishment of the communication channel requested in operation 402.

From operation 408, the method 400 can proceed to operation 410. The method 400 also can proceed to operation 410 from operation 406. At operation 410, the gateway 108 can include the connection decision in display data 132. At operation 410, the gateway 108 can generate display data 132 that indicates the allowing of a communication associated with the Internet-of-things device 102, blocking of a communication associated with the Internet-of-things device 102, not allowing establishment of a communication channel associated with the Internet-of-things device 102, allowing establishment of a communication channel associated with the Internet-of-things device 102, and/or other actions as taken in operation 406 or operation 408.

The gateway 108 can generate the display data 132, as explained above, for providing to a user or other entity via a portal, user interface, or the like. As explained above, a user or other entity can view the display data 132 and act on the data as illustrated and described herein. Thus, although not shown separately in FIG. 4, the display data 132 can be provided to the user device 134 or made accessible to the user device 134 for additional operations as illustrated and described herein.

From operation 410, the method 400 can proceed to operation 412. The method 400 can end at operation 412.

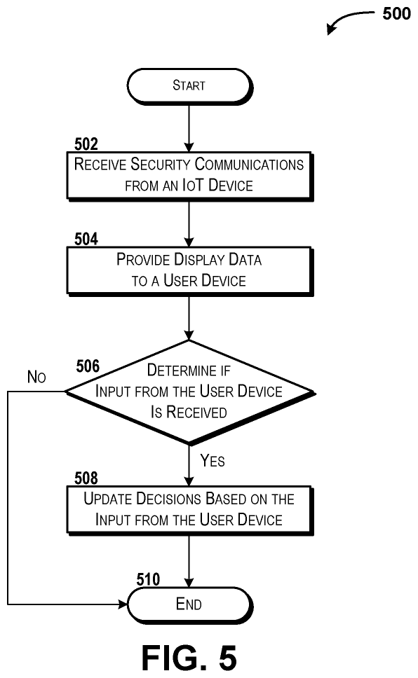

Turning now to FIG. 5, aspects of a method 500 for user-level security management for an Internet-of-things device 102 will be described in detail, according to an illustrative embodiment. For purposes of illustrating and describing the concepts of the present disclosure, the method 500 is described herein as being performed by the gateway 108 via execution of one or more software modules such as, for example, the Internet-of-things hub 106. It should be understood that additional and/or alternative devices and/or network nodes can provide the functionality described herein via execution of one or more modules, applications, and/or other software including, but not limited to, the Internet-of-things hub 106. Thus, the illustrated embodiments are illustrative, and should not be viewed as being limiting in any way.

The method 500 begins at operation 502. At operation 502, the gateway 108 can receive security communications 118 from an Internet-of-things device 102. As explained above, the security communications 118 received (or otherwise obtained) in operation 502 can indicate connections associated with the Internet-of-things device 102 such as connections to the Internet-of-things device 102, transfers of data to the Internet-of-things device 102, connections from the Internet-of-things device 102, transfers of data from the Internet-of-things device 102, attempted communications to and/or from the Internet-of-things device 102, and/or other communications as illustrated and described herein.

From operation 502, the method 500 can proceed to operation 504. At operation 504, the gateway 108 can provide display data 132 to a user device 134. As illustrated and described herein, operation 504 can include generating the display data 132. As explained above, the display data 132 can include renderable data for generating a user interface, in some embodiments, or other visual data that can be presented and/or interacted with by a portal, webpage, or other functionality that can be hosted by the Internet-of-things hub 106.

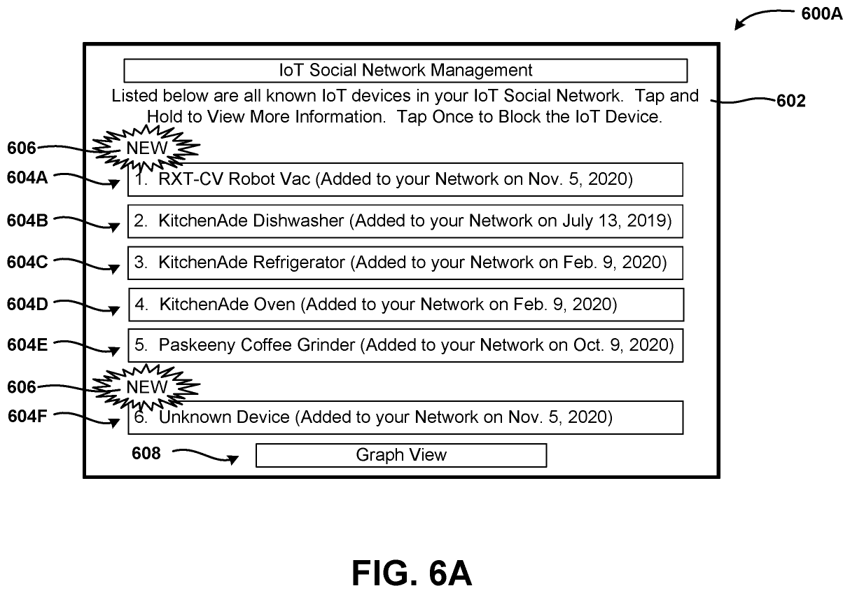

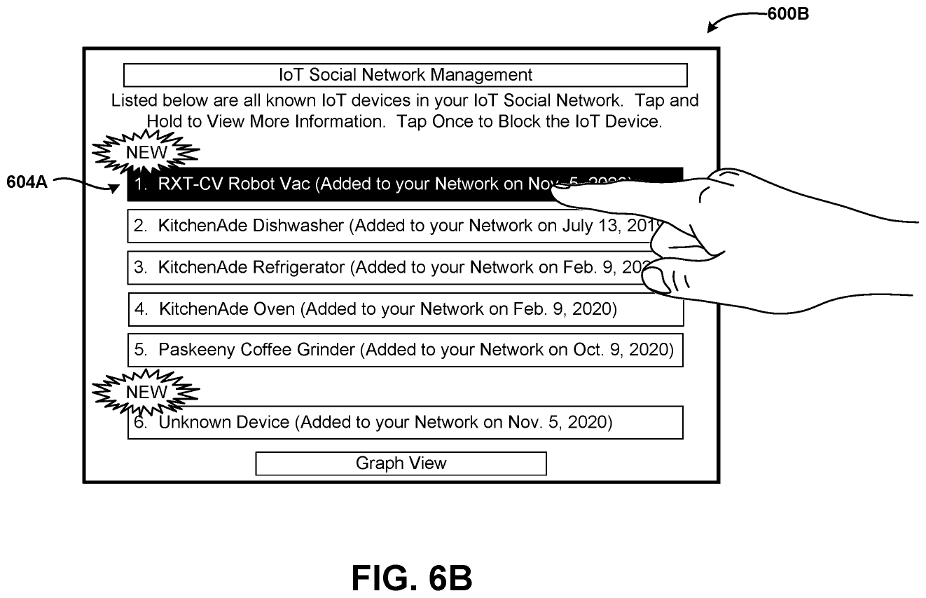

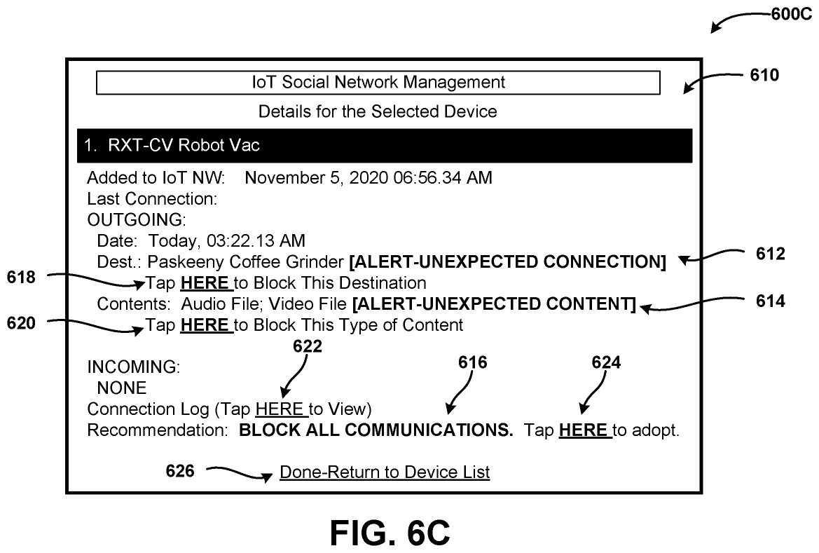

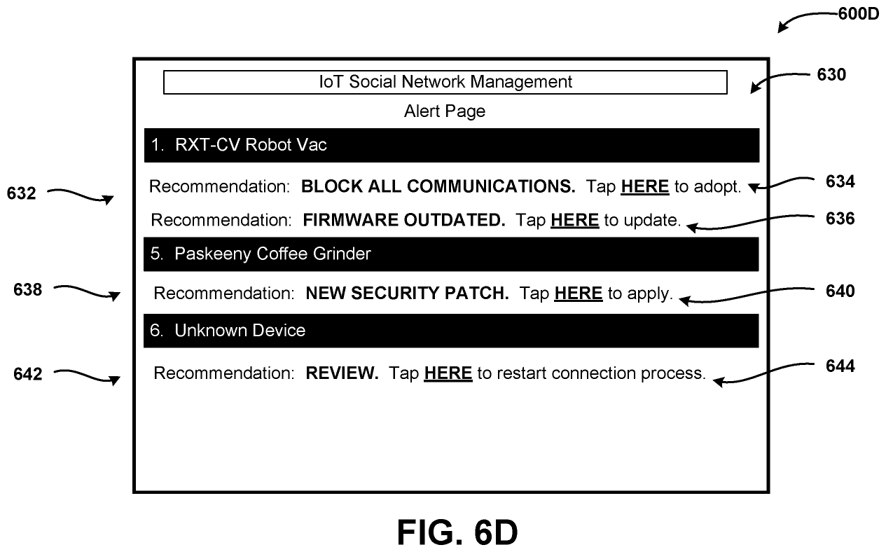

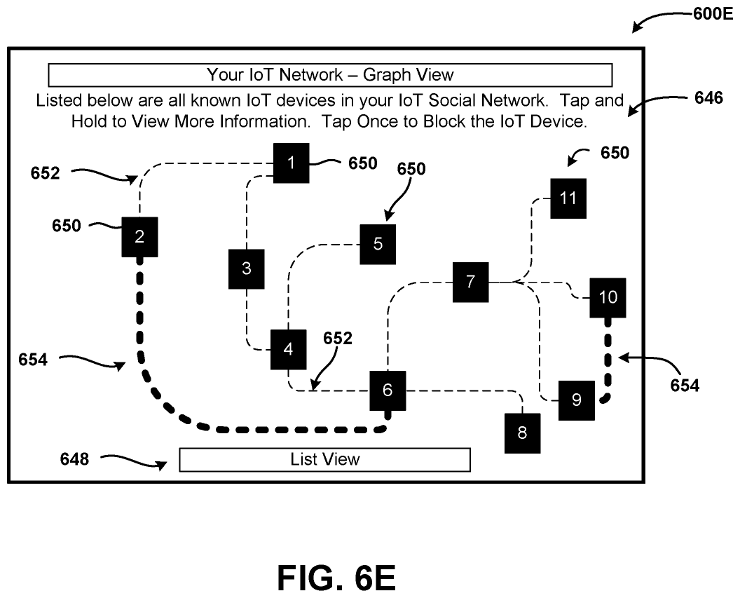

The gateway 108 can provide the display data 132 to a device such as the user device 134 via transmitting the display data 132 to the user device 134, via enabling a download of the display data 132 to the user device 134, via enabling access to the display data 134 via a webpage or portal at the gateway 108, and/or otherwise making the display data 134 available to the user device 134. As explained above, and as will be illustrated and described below with reference to FIGS. 6A-6E, the display data 132 can include instructions for presenting a user interface with selectable UI elements to perform various operations with respect to the Internet-of-things devices 102 and/or communications to, from, and/or between the Internet-of-things devices 102.

From operation 504, the method 500 can proceed to operation 506. In operation 506, the gateway 108 can determine if input 136 from the user device 134 has been received. In some embodiments, the input 136 can indicate selection of user interface elements to block communications, limit communications, enable communications, remove Internet-of-things devices 102 from the Internet-of-things network 104, to onboard Internet-of-things device 102 to the Internet-of-things network 104, and/or to otherwise control communications as illustrated and described herein.

If the gateway 108 determines, in operation 506, that the input 136 from the user device 134 has been received, the method 500 can proceed to operation 508. At operation 508, the gateway 108 can update one or more decisions based on the input 136 from the user device 134. As explained above, the gateway 108 can control communications and/or can instruct the Internet-of-things devices 102 to control communications. Additionally, the gateway 108 can download updates 122 (e.g., updates for firmware 112, security patches, software updates, etc.) and, optionally, send the updates 122 or portions thereof to the Internet-of-things devices 102. Because other changes can be made to communications and/or the Internet-of-things devices 102 as illustrated and described herein, it should be understood that these examples are illustrative, and therefore should not be construed as being limiting in any way.

If the gateway 108 determines, in operation 506, that the input 136 from the user device 134 has not been received, the method 500 can proceed to operation 510. The method 500 also can proceed to operation 510 from operation 506. The method 500 can end at operation 510.

FIGS. 6A-6E are user interface (“UI”) diagrams showing aspects of UIs for using and/or interacting with the Internet-of-things hub 106, according to some illustrative embodiments. FIG. 6A shows an illustrative screen display 600A. According to some embodiments of the concepts and technologies described herein, the screen display 600A can be generated by a device such as, for example, the user device 134 based on display data 132, which can be generated by the Internet-of-things hub 106. In particular, according to various embodiments, the user device 134 can generate the screen display 600A and/or other screen displays in conjunction with and/or based upon interactions with the gateway 108 and/or the Internet-of-things hub 106 hosted thereon. The Internet-of-things hub 106 can generate the display data 132 and provide the display data 132 to the user device 134, which can be configured to render the screen display 600A using the display data 132. It should be appreciated that the UI diagram illustrated in FIG. 6A is illustrative of one contemplated example of the UIs that can be generated and/or displayed by various devices in accordance with the concepts and technologies disclosed herein, and therefore should not be construed as being limited in any way.

The screen display 600A can include various menus and/or menu options (not visible in FIG. 6A). The screen display 600A also can include an Internet-of-things social network management screen 602. The Internet-of-things social network management screen 602 can be configured to enable a user or other entity (e.g., a homeowner or office owner at which the gateway 108 and the Internet-of-things devices 102 are located) to view and manage Internet-of-things devices 102 associated with an

Internet-of-things network 104. In the illustrated embodiment, the Internet-of-things social network management screen 602 includes various types of data and/or information associated with various Internet-of-things devices 102 that have been detected in the Internet-of-things network 104 and/or in a proximity of the gateway 108 that hosts the Internet-of-things hub 106. It should be understood that the illustrated embodiment is illustrative and should not be construed as being limiting in any way.

As shown in FIG. 6A, and as illustrated and described herein, the Internet-of-things social network management screen 602 can include one or more UI elements for presenting text and/or for obtaining input from a user or other entity. In the illustrated embodiment, the UI elements can include text and selectable controls. In particular, the Internet-of-things social network management scree 602 shown in FIG. 6A can include multiple Internet-of-things device indicator/selector elements 604A-F (hereinafter collectively and/or generically referred to as “Internet-of-things device indicator/selector elements 604”). One or more of the Internet-of-things indicator/selector elements 604 can a) present text that identifies Internet-of-things devices 102 on the Internet-of-things social network (e.g., the Internet-of-things network 104 shown in FIG. 1) and/or b) provide a selectable control that provides input such as the input 136 to the Internet-of-things hub 106 to take various actions as may be indicated on the Internet-of-things social network management screen 602 or elsewhere.

In the illustrated embodiment, the Internet-of-things social network management screen 602 shows six Internet-of-things device indicator/selector elements 604. It should be understood that the Internet-of-things social network management screen 602 can include any number of Internet-of-things device indicator/selector elements 604 and/or similar or equivalent elements. Also, it should be understood that the example Internet-of-things devices 102 are merely illustrative and therefore should not be construed as being limiting in any way.

As shown in FIG. 6A, various Internet-of-things devices 102 have been detected as being connected to the Internet-of-things network 104. As shown in FIG. 6A, the Internet-of-things device indicator/selector elements 604 can include various types of information. The illustrated embodiment of the Internet-of-things device indicator/selector elements 604 include text indicating a date the Internet-of-things device 102 (that is represented by the associated Internet-of-things device indicator/selector element 604) was added to the Internet-of-things network 104 and/or established connectivity with the gateway 108.

As shown in FIG. 6A, two of the Internet-of-things device indicator/selector elements 604, namely the Internet-of-things device indicator/selector element 604A and the Internet-of-things device indicator/selector element 604F, are displayed with indicators 606, which indicate that the Internet-of-things devices 102 associated with the Internet-of-things device indicator/selector elements 604 have been newly added to the Internet-of-things network 104 and/or established connectivity with the gateway 108. In some embodiments, these indicators 606 can be included to inform the user or other entity of the newly added Internet-of-things devices 102, as in some cases newly added Internet-of-things devices 102 may be suspected of being malicious. Of course, it can be appreciated that the indicators 606 and this indication is purely illustrative, as other information including, but not limited to, the information illustrated and described herein can be presented on the Internet-of-things device indicator/selector elements 604 if desired.

According to various embodiments of the concepts and technologies disclosed herein, the Internet-of-things device indicator/selector elements 604 can be selected to block the associated Internet-of-things device 102, to view more information, to disconnect the Internet-of-things device 102, and/or to take other operations with respect to the Internet-of-things devices 102. In the illustrated embodiment, tapping and holding (or right button clicking, or using other input with respect to) one of the Internet-of-things device indicator/selector elements 604 can cause the device displaying the Internet-of-things social network management screen 602 to display more information associated with the associated Internet-of-things device 102.

Similarly, in the illustrated embodiment, tapping without holding (or left button clicking, or using other input with respect to) one of the Internet-of-things device indicator/selector elements 604 can cause the device displaying the Internet-of-things social network management screen 602 to generate input 136 for blocking the Internet-of-things device 102 associated with the selected Internet-of-things device indicator/selector element 604. It should be understood that because these operations are merely illustrative, that these embodiments should not be construed as being limiting in any way. An example embodiment of a screen display that can be presented in response to detecting a tap and hold, right click, or other input with respect to one of the Internet-of-things device indicator/selector element 604 (as shown in FIG. 6B) will be described now with reference to FIG. 6C.

FIG. 6C shows an illustrative screen display 600C. According to some embodiments of the concepts and technologies described herein, the screen display 600C can be generated by a device such as, for example, the user device 134 based on display data 132, which can be generated by the Internet-of-things hub 106. In particular, according to various embodiments, the user device 134 can generate the screen display 600C and/or other screen displays in response to a user or other entity selecting the Internet-of-things device indicator/selector element 604A of FIGS. 6A-6B, as shown in FIG. 6B. Because the screen display 600C can be presented at additional and/or alternative times, it should be understood that this example is illustrative and should not be construed as being limiting in any way. Furthermore, because the contents of the screen display 600C shown in FIG. 6C are illustrative, it should be appreciated that the UI diagram illustrated in FIG. 6C is illustrative of one contemplated example of the UIs that can be generated and/or displayed by various devices in accordance with the concepts and technologies disclosed herein, and therefore should not be construed as being limited in any way.

The screen display 600C can include various menus and/or menu options (not visible in FIG. 6C). The screen display 600C also can include an Internet-of-things device details screen 610. The Internet-of-things device details screen 610 can be configured to enable a user or other entity (e.g., a homeowner or office owner at which the gateway 108 and the Internet-of-things devices 102 are located) to view and manage connections and/or communications associated with a particular Internet-of-things device 102. In the illustrated embodiment, the Internet-of-things device details screen 610 presents various information associated with the example Internet-of-things device 102 such as, for example, a time the Internet-of-things device 102 was added to or detected in the Internet-of-things network 104 (or in connectivity with the gateway 108), information associated with a last outgoing connection detected for the Internet-of-things device 102 (e.g., a time and date the connection occurred, a destination device, contents of the communication, etc.), a last incoming connection detected for the Internet-of-things device 102, and/or other information. Because other information can be displayed in the screen display 600C, it should be understood that the illustrated embodiment is illustrative and should not be construed as being limiting in any way.

As shown in FIG. 6C, and as illustrated and described herein, some embodiments of the Internet-of-things device details screen 610 also can include a number of alerts, recommendations, links to additional information or actions, and/or other information. With regard to alerts, the Internet-of-things device details screen 610 includes a first alert 612, which can indicate that the destination of a last detected outgoing connection is unexpected. Namely, there may not be any reasonable explanation for a robot vacuum to communicate with a coffee grinder. As such, communications or connections such as these may be unexpected and may call for additional analysis to determine if malicious activity is occurring in the Internet-of-things network 104. The Internet-of-things device details screen 610 shown in FIG. 6C also includes a second alert 614, which can indicate that the contents of the last detected outgoing connection is unexpected. Namely, there may not be any reasonable explanation for a robot vacuum to send video and audio to any other device, let alone a coffee grinder. Again, such communications or connections such as these may be unexpected and may call for additional analysis to determine if malicious activity is occurring in the Internet-of-things network 104. The first alert 612 and the second alert 614 can be included in some embodiments to inform a user or other entity that unexpected communications have occurred. It should be understood that this example is illustrative, and therefore should not be construed as being limiting in any way.

With regard to recommendations, the Internet-of-things device details screen 610 can include one or more recommendations 616. As shown in FIG. 6C, the recommendation 616 can inform a user or other entity that the Internet-of-things device 102 associated with the details being displayed in the Internet-of-things device details screen 610 should be blocked from making any communications. Other actions can be recommended, for example blocking some communications, redoing an onboarding process for the Internet-of-things device 102, or the like. As such, the illustrated embodiment should not be construed as being limiting in any way.

With regard to UI elements that can correspond to links and/or operations, the Internet-of-things device details screen 610 can include one or more links such as, for example, a first UI element 618 to block communications with a particular destination, a second UI element 620 to block specific types of content, a third UI element 622 to view a connection log for the Internet-of-things device 102, and a fourth UI element 624 to adopt the recommendation 616. Because other UI elements associated with other links and/or operations are contemplated and are possible, it should be understood that these examples are illustrative, and therefore should not be construed as being limiting in any way.

It can be appreciated that through interactions with the screen display 600C, a user or other entity can cause the device displaying the screen display 600C (e.g., the user device 134) to generate the input 136 and/or to trigger delivery of the input 136 to the gateway 108. Thus, in some embodiments of the concepts and technologies disclosed herein, the screen display 600C can enable one-tap or one-click blocking of communications and/or connections associated with one or more Internet-of-things devices 102, among other features. In the illustrated embodiment of the screen display 600C, a link 626 to return to a list of Internet-of-things devices 102 (e.g., such as that shown in FIGS. 6A-6B). It should be understood that this example is illustrative, and therefore should not be construed as being limiting in any way.

FIG. 6D shows an illustrative screen display 600D. According to some embodiments of the concepts and technologies described herein, the screen display 600D can be generated by a device such as, for example, the user device 134 based on display data 132, which can be generated by the Internet-of-things hub 106. In particular, according to various embodiments, the user device 134 can generate the screen display 600D and/or other screen displays in response to the user device 134 receiving the display data 132. Because the screen display 600D can be presented at additional and/or alternative times, it should be understood that this example is illustrative and should not be construed as being limiting in any way. Furthermore, because the contents of the screen display 600D shown in FIG. 6D are illustrative, it should be appreciated that the UI diagram illustrated in FIG. 6D is illustrative of one contemplated example of the UIs that can be generated and/or displayed by various devices in accordance with the concepts and technologies disclosed herein, and therefore should not be construed as being limited in any way.

The screen display 600D can include various menus and/or menu options (not visible in FIG. 6D). The screen display 600D also can include an Internet-of-things network alert screen 630. The Internet-of-things network alert screen 630 can be configured to display (e.g., to a user or other entity such as a homeowner or office owner at which the gateway 108 and the Internet-of-things devices 102 are located) to view and/or act on alerts associated with one or more Internet-of-things devices 102, the gateway 108, the Internet-of-things hub 106, and/or the Internet-of-things network 104. Because other alerts are possible and are contemplated, it should be understood that the illustrated embodiment is illustrative and should not be construed as being limiting in any way.

In the illustrated embodiment, the Internet-of-things network alert screen 630 presents alerts associated with multiple Internet-of-things devices 102. In particular, the Internet-of-things network alert screen 630 shows a first area of alerts 632, which can display alert information associated with a first Internet-of-things device 102, in the illustrated embodiment, a robot vacuum. It should be understood that this example is illustrative, and therefore should not be construed as being limiting in any way.

The first area of alerts 632 can include, for example, one or more recommendations for addressing one or more security concerns. In the illustrated embodiment, the first area of alerts 632 includes a first alert or recommendation 634 to block all communications associated with the Internet-of-things device 102 associated with the first area of alerts 632, e.g., the robot vacuum. As shown in FIG. 6D, and as described above with reference to FIG. 6C, the first alert or recommendation 634 can include a link or UI element to adopt the recommendation. It can be appreciated that selection of the link or UI element can cause the device displaying the screen display 600D, e.g., the user device 134, to generate input 136 for blocking communications of the Internet-of-things device 102 by the gateway 108. It can be appreciated that the gateway 108 can block any communications associated with the blocked Internet-of-things device 102 that occur via the gateway 108, and/or that the gateway 108 can instruct other Internet-of-things devices 102 on the Internet-of-things network 104 to block incoming communications from the blocked Internet-of-things device 102. Because communications associated with the blocked Internet-of-things device 102 can be blocked in additional and/or alternative manners, it should be understood that these examples are illustrative, and therefore should not be construed as being limiting in any way.

The first area of alerts 632 is illustrated as including a second alert or recommendation 636 to update a firmware associated with the Internet-of-things device 102 associated with the first area of alerts 632, e.g., the robot vacuum. As shown in FIG. 6D, and as described above with reference to FIG. 6C, the second alert or recommendation 636 can include a link or UI element to adopt the recommendation. It can be appreciated that selection of the link or UI element can cause the device displaying the screen display 600D, e.g., the user device 134, to generate input 136 for updating the firmware 112 of the Internet-of-things device 102 by the gateway 108. It can be appreciated that the gateway 108 can obtain an update 122 from the security management service 124 or other entity (e.g., a manufacturer website, security bulletin, or the like) and send the firmware update (or instructions to update the firmware 112) to the Internet-of-things device 102, e.g., as the security communications 118 or other communications. Because the firmware 112 of the Internet-of-things device 102 can be updated in additional and/or alternative manners, it should be understood that the above example is illustrative, and therefore should not be construed as being limiting in any way.

The Internet-of-things network alert screen 630 also can include a second area of alerts 638, which can display alert information associated with a second Internet-of-things device 102, in the illustrated embodiment, a coffee grinder. It should be understood that this example is illustrative, and therefore should not be construed as being limiting in any way.

The second area of alerts 638 can include, for example, one or more recommendations for addressing one or more security concerns. In the illustrated embodiment, the second area of alerts 638 includes a third alert or recommendation 640 to apply a new security patch to the Internet-of-things device 102 associated with the second area of alerts 638, e.g., the coffee grinder. As shown in FIG. 6D, and as described above with reference to FIG. 6C, the third alert or recommendation 640 can include a link or UI element to adopt the recommendation. It can be appreciated that selection of the link or UI element can cause the device displaying the screen display 600D, e.g., the user device 134, to generate input 136 to cause the gateway 108 to install the new security patch or to instruct the associated Internet-of-things device 102 to install the new security patch. In some embodiments, the gateway 108 can obtain an update 122 from the security management service 124 or other entity (e.g., a manufacturer website, security bulletin, or the like) and install the security patch. In some other embodiments, the gateway 108 can obtain an update 122 from the security management service 124 or other entity and provide the new security patch to the Internet-of-things device 102 (e.g., via the security communications 118). Because the security patch can be applied to the gateway 108 and/or the Internet-of-things device 102 in additional and/or alternative manners, it should be understood that the above example is illustrative, and therefore should not be construed as being limiting in any way.

The Internet-of-things network alert screen 630 also can include a third area of alerts 642, which can display alert information associated with a third Internet-of-things device 102, in the illustrated embodiment, an unknown device. It should be understood that this example is illustrative, and therefore should not be construed as being limiting in any way.

The third area of alerts 642 can include, for example, one or more recommendations for addressing one or more security concerns. In the illustrated embodiment, the third area of alerts 642 includes a fourth alert or recommendation 644 to review the connection with the associated Internet-of-things device 102. As shown in FIG. 6D, and as described above with reference to FIG. 6C, the fourth alert or recommendation 644 can include a link or UI element to adopt the recommendation. It can be appreciated that selection of the link or UI element can cause the device displaying the screen display 600D, e.g., the user device 134, to generate input 136 to cause the gateway 108 to disconnect the associated Internet-of-things device 102 from the gateway 108 and/or to restart the onboarding process illustrated and described herein, which can ensure that the Internet-of-things device 102 is authorized to communication via the gateway 108. Because the connection associated with the Internet-of-things device 102 can be reviewed in additional and/or alternative manners, it should be understood that the above example is illustrative, and therefore should not be construed as being limiting in any way.

FIG. 6E shows an illustrative screen display 600E. According to some embodiments of the concepts and technologies described herein, the screen display 600E can be generated by a device such as, for example, the user device 134 based on display data 132, which can be generated by the Internet-of-things hub 106. In particular, according to various embodiments, the user device 134 can generate the screen display 600E and/or other screen displays in response to a user or other entity selecting the UI option 608 of FIGS. 6A-6B. Because the screen display 600E can be presented at additional and/or alternative times, it should be understood that this example is illustrative and should not be construed as being limiting in any way. Furthermore, because the contents of the screen display 600E shown in FIG. 6E are illustrative, it should be appreciated that the UI diagram illustrated in FIG. 6E is illustrative of one contemplated example of the UIs that can be generated and/or displayed by various devices in accordance with the concepts and technologies disclosed herein, and therefore should not be construed as being limited in any way.

The screen display 600E can include various menus and/or menu options (not visible in FIG. 6E). The screen display 600E also can include an Internet-of-things social network graph display screen 610. The Internet-of-things social network graph display screen 646 can be configured to enable a user or other entity (e.g., a homeowner or office owner at which the gateway 108 and the Internet-of-things devices 102 are located) to view and manage connections and/or communications associated with multiple or even all Internet-of-things devices 102 in an Internet-of-things network 104 and/or an Internet-of-things social network. The Internet-of-things social network graph display screen 646 also can include a UI option 648 to display a list view of the Internet-of-things network 104. It can be appreciated that selection of the UI option 648 can prompt the device showing the screen display 600E, for example the user device 134, to present a list view such as the view shown in FIGS. 6A-6B. It should be understood that this example is illustrative, and therefore should not be construed as being limiting in any way.

In the illustrated embodiment, the Internet-of-things social network graph display screen 646 presents various information associated with the example Internet-of-things network 104. In particular, the Internet-of-things social network graph display screen 646 shown in FIG. 6E shows multiple node icons 650, which can represent nodes on the Internet-of-things network 104. In the Internet-of-things social network graph display screen 646, the node icons 650 (and the nodes) can represent Internet-of-things devices 102. it should be understood that this example is illustrative, and therefore should not be construed as being limiting in any way.

The Internet-of-things social network graph display screen 646 also depicts connections or links (“links”) 652 between the Internet-of-things devices 102 represented by the node icons 650. These links 652 can illustrate how the Internet-of-things devices 602 represented by the node icons 650 communicate with one another. It can be appreciated with reference to FIG. 6E, for example, that Internet-of-things device 1 communicates with Internet-of-things devices 2 and 3; that Internet-of-things device 3 communicates with Internet-of-things device 4; that Internet-of-things device 2 communicates with Internet-of-things device 6; that Internet-of-things device 4 communicates with Internet-of-things devices 5 and 6; that Internet-of-things device 6 communicates with Internet-of-things devices 7 and 8; and that Internet-of-things device 7 communicates with Internet-of-things devices 9, 10, and 11. It should be understood that this example is illustrative, and therefore should not be construed as being limiting in any way.

As shown in FIG. 6E, some of the links 652 between Internet-of-things devices 102 can be depicted differently. In particular, between the node icons 650 for Internet-of-things devices 2 and 6 and Internet-of-things devices 9 and 10 are alert links 654. The alert links 654 can indicate an unexpected communication link between Internet-of-things devices 102 and/or an expected link between Internet-of-things devices 102, but unexpected communications. It should be understood that this example is illustrative, and therefore should not be construed as being limiting in any way. The node icons 650, links 652, and alert links 654 in the Internet-of-things social network graph display screen 646 can correspond to UI features, so tapping or clicking these or other elements may cause a display of additional information associated with the respective links and/or Internet-of-things devices 102. It should be understood that this example is illustrative, and therefore should not be construed as being limiting in any way

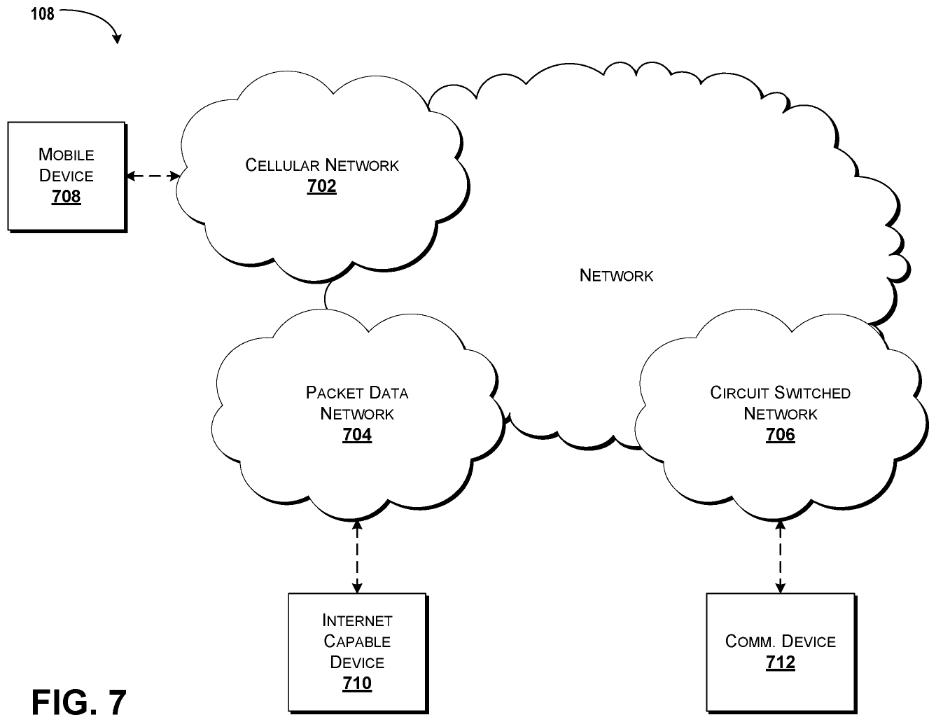

Turning now to FIG. 7, additional details of the network 110 are illustrated, according to an illustrative embodiment. The network 110 includes a cellular network 702, a packet data network 704, for example, the Internet, and a circuit switched network 706, for example, a publicly switched telephone network (“PSTN”). The cellular network 702 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 702 also includes radios and nodes for receiving and transmitting voice, data, and combinations thereof to and from radio transceivers, networks, the packet data network 704, and the circuit switched network 706.

A mobile communications device 708, such as, for example, a cellular telephone, a user equipment, a mobile terminal, a PDA, a laptop computer, a handheld computer, and combinations thereof, can be operatively connected to the cellular network 702. The cellular network 702 can be configured as a 2G GSM network and can provide data communications via GPRS and/or EDGE. Additionally, or alternatively, the cellular network 702 can be configured as a 3G UMTS network and can provide data communications via the HSPA protocol family, for example, HSDPA, EUL (also referred to as HSDPA), and HSPA+. The cellular network 702 also is compatible with 4G mobile communications standards as well as evolved and future mobile standards.

The packet data network 704 includes various devices, for example, servers, computers, databases, and other devices in communication with one another, as is generally known. The packet data network 704 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 704 includes or is in communication with the Internet. The circuit switched network 706 includes various hardware and software for providing circuit switched communications. The circuit switched network 706 may include, or may be, what is often referred to as a plain old telephone system (POTS). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable devices 710, for example, a PC, a laptop, a portable device, or another suitable device, can communicate with one or more cellular networks 702, and devices connected thereto, through the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710. In the specification, the network 110 is used to refer broadly to any combination of the networks 702, 704, 706. It should be appreciated that substantially all of the functionality described with reference to the network 110 can be performed by the cellular network 702, the packet data network 704, and/or the circuit switched network 706, alone or in combination with other networks, network elements, and the like.

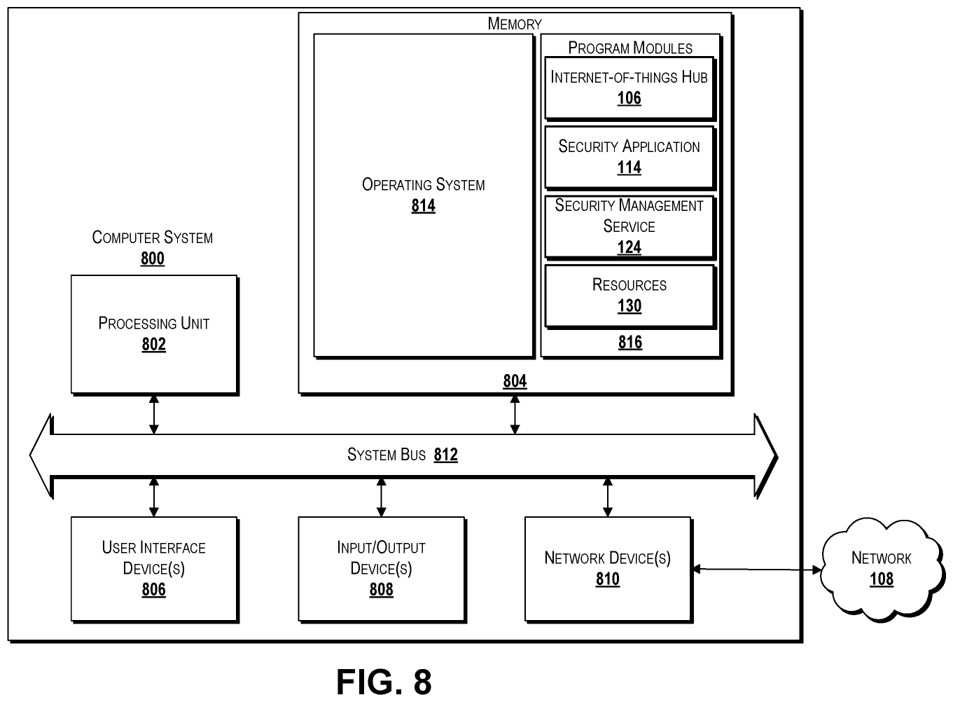

FIG. 8 is a block diagram illustrating a computer system 800 configured to provide the functionality described herein for security management for Internet-of-things devices, in accordance with various embodiments of the concepts and technologies disclosed herein. The computer system 800 includes a processing unit 802, a memory 804, one or more user interface devices 806, one or more input/output (“I/O”) devices 808, and one or more network devices 810, each of which is operatively connected to a system bus 812. The bus 812 enables bi-directional communication between the processing unit 802, the memory 804, the user interface devices 806, the I/O devices 808, and the network devices 810.

The processing unit 802 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 804 communicates with the processing unit 802 via the system bus 812. In some embodiments, the memory 804 is operatively connected to a memory controller (not shown) that enables communication with the processing unit 802 via the system bus 812. The memory 804 includes an operating system 814 and one or more program modules 816. The operating system 814 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 816 may include various software and/or program modules described herein. In some embodiments, for example, the program modules 816 include the Internet-of-things hub 106, the security application 114, the security management service 124, and/or the resource 130. These and/or other programs can be embodied in computer-readable media containing instructions that, when executed by the processing unit 802, perform one or more of the methods 200, 300, 400, and/or 500 described in detail above with respect to FIGS. 2-5 and/or other functionality as illustrated and described herein. It can be appreciated that, at least by virtue of the instructions embodying the methods 200, 300, 400, and/or 500 and/or other functionality illustrated and described herein being stored in the memory 804 and/or accessed and/or executed by the processing unit 802, the computer system 800 is a special-purpose computing system that can facilitate providing the functionality illustrated and described herein. According to embodiments, the program modules 816 may be embodied in hardware, software, firmware, or any combination thereof. Although not all shown in FIG. 8, it should be understood that the memory 804 also can be configured to store the firmware 112, the security communications 118, the connection policies 120, the updates 122, the resource 130, the display data 132, the input 136, the malware 138, and/or other data, if desired.

By way of example, and not limitation, computer-readable media may include any available computer storage media or communication media that can be accessed by the computer system 800. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 800. In the claims, the phrase “computer storage medium” and variations thereof does not include waves or signals per se and/or communication media.

The user interface devices 806 may include one or more devices with which a user accesses the computer system 800. The user interface devices 806 may include, but are not limited to, computers, servers, personal digital assistants, cellular phones, or any suitable computing devices. The I/O devices 808 enable a user to interface with the program modules 816. In one embodiment, the I/O devices 808 are operatively connected to an I/O controller (not shown) that enables communication with the processing unit 802 via the system bus 812. The I/O devices 808 may include one or more input devices, such as, but not limited to, a keyboard, a mouse, or an electronic stylus. Further, the I/O devices 808 may include one or more output devices, such as, but not limited to, a display screen or a printer.

The network devices 810 enable the computer system 800 to communicate with other networks or remote systems via a network, such as the network 110. Examples of the network devices 810 include, but are not limited to, a modem, a radio frequency (“RF”) or infrared (“IR”) transceiver, a telephonic interface, a bridge, a router, or a network card. The network 110 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 110 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

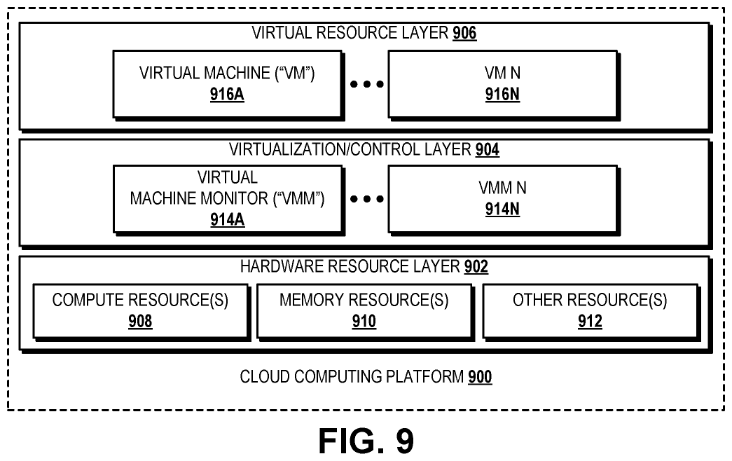

FIG. 9 illustrates an illustrative architecture for a cloud computing platform 900 that can be capable of executing the software components described herein for security management for Internet-of-things devices and/or for interacting with the Internet-of-things hub 106, the security application 114, the security management service 124, and/or the resource 130. Thus, it can be appreciated that in some embodiments of the concepts and technologies disclosed herein, the cloud computing platform 900 illustrated in FIG. 9 can be used to provide the functionality described herein with respect to the Internet-of-things devices 102, the gateway 108, the resource 130, and/or the user device 134.

The cloud computing platform 900 thus may be utilized to execute any aspects of the software components presented herein. Thus, according to various embodiments of the concepts and technologies disclosed herein, the Internet-of-things hub 106, the security application 114, the security management service 124, and/or the resource 130 can be implemented, at least in part, on or by elements included in the cloud computing platform 900 illustrated and described herein. Those skilled in the art will appreciate that the cloud computing platform 900 illustrated in FIG. 9 is a simplification of but only one possible implementation of an illustrative cloud computing platform, and as such, the illustrated cloud computing platform 900 should not be construed as being limiting in any way.

In the illustrated embodiment, the cloud computing platform 900 can include a hardware resource layer 902, a virtualization/control layer 904, and a virtual resource layer 906. These layers and/or other layers can be configured to cooperate with each other and/or other elements of a cloud computing platform 900 to perform operations as will be described in detail herein. While connections are shown between some of the components illustrated in FIG. 9, it should be understood that some, none, or all of the components illustrated in FIG. 9 can be configured to interact with one another to carry out various functions described herein. In some embodiments, the components are arranged so as to communicate via one or more networks such as, for example, the network 110 illustrated and described hereinabove (not shown in FIG. 9). Thus, it should be understood that FIG. 9 and the following description are intended to provide a general understanding of a suitable environment in which various aspects of embodiments can be implemented, and should not be construed as being limiting in any way.

The hardware resource layer 902 can provide hardware resources. In the illustrated embodiment, the hardware resources can include one or more compute resources 908, one or more memory resources 910, and one or more other resources 912. The compute resource(s) 908 can include one or more hardware components that can perform computations to process data, and/or to execute computer-executable instructions of one or more application programs, operating systems, services, and/or other software including, but not limited to, the Internet-of-things hub 106, the security application 114, the security management service 124, and/or the resource 130 illustrated and described herein.

According to various embodiments, the compute resources 908 can include one or more central processing units (“CPUs”). The CPUs can be configured with one or more processing cores. In some embodiments, the compute resources 908 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 908 can include one or more discrete GPUs. In some other embodiments, the compute resources 908 can include one or more CPU and/or GPU components that can be configured in accordance with a co-processing CPU/GPU computing model. Thus, it can be appreciated that in some embodiments of the compute resources 908, a sequential part of an application can execute on a CPU and a computationally-intensive part of the application can be accelerated by the GPU. It should be understood that this example is illustrative, and therefore should not be construed as being limiting in any way.

In some embodiments, the compute resources 908 also can include one or more system on a chip (“SoC”) components. It should be understood that the an SoC component can operate in association with one or more other components as illustrated and described herein, for example, one or more of the memory resources 910 and/or one or more of the other resources 912. In some embodiments in which an SoC component is included, the compute resources 908 can be or can include one or more embodiments of the SNAPDRAGON brand family of SoCs, available from QUALCOMM of San Diego, Calif.; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Tex.; one or more customized versions of any of the above SoCs; and/or one or more other brand and/or one or more proprietary SoCs.

The compute resources 908 can be or can include one or more hardware components arranged in accordance with an ARM architecture, available for license from ARM HOLDINGS of Cambridge, United Kingdom. Alternatively, the compute resources 908 can be or can include one or more hardware components arranged in accordance with an x86 architecture, such as an architecture available from INTEL CORPORATION of Mountain View, Calif., and others. Those skilled in the art will appreciate the implementation of the compute resources 908 can utilize various computation architectures and/or processing architectures. As such, the various example embodiments of the compute resources 908 as mentioned hereinabove should not be construed as being limiting in any way. Rather, implementations of embodiments of the concepts and technologies disclosed herein can be implemented using compute resources 908 having any of the particular computation architecture and/or combination of computation architectures mentioned herein as well as other architectures.

Although not separately illustrated in FIG. 9, it should be understood that the compute resources 908 illustrated and described herein can host and/or execute various services, applications, portals, and/or other functionality illustrated and described herein. Thus, the compute resources 908 can host and/or can execute the Internet-of-things hub 106, the security application 114, the security management service 124, and/or the resource 130 or other applications or services illustrated and described herein.

The memory resource(s) 910 can include one or more hardware components that can perform or provide storage operations, including temporary and/or permanent storage operations. In some embodiments, the memory resource(s) 910 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 908, subject to the definition of “computer storage media” provided above (e.g., as excluding waves and signals per se and/or communication media as defined in this application).

Although not illustrated in FIG. 9, it should be understood that the memory resources 910 can host or store the various data illustrated and described herein including, but not limited to, the firmware 112, the security communications 118, the connection policies 120, the updates 122, the resource 130, the display data 132, the input 136, the malware 138, and/or other data, if desired. It should be understood that this example is illustrative, and therefore should not be construed as being limiting in any way.

The other resource(s) 912 can include any other hardware resources that can be utilized by the compute resources(s) 908 and/or the memory resource(s) 910 to perform operations. The other resource(s) 912 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 902 can be virtualized by one or more virtual machine monitors (“VMMs”) 914A-914N (also known as “hypervisors;” hereinafter “VMMs 914”). The VMMs 914 can operate within the virtualization/control layer 904 to manage one or more virtual resources that can reside in the virtual resource layer 906. The VMMs 914 can be or can include software, firmware, and/or hardware that alone or in combination with other software, firmware, and/or hardware, can manage one or more virtual resources operating within the virtual resource layer 906.

The virtual resources operating within the virtual resource layer 906 can include abstractions of at least a portion of the compute resources 908, the memory resources 910, the other resources 912, or any combination thereof. These abstractions are referred to herein as virtual machines (“VMs”). In the illustrated embodiment, the virtual resource layer 906 includes VMs 916A-916N (hereinafter “VMs 916”).

Based on the foregoing, it should be appreciated that systems and methods for security management for Internet-of-things devices have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a gateway comprising processor; and
a memory that stores computer-executable instructions that, when executed by the processor, cause the processor to perform operations comprising
detecting, at the gateway using an Internet-of-things hub, a communication associated with an Internet-of-things device, wherein the communication comprises an attempt for the Internet-of-things device to communicate with another device,
determining, by the gateway and based on connection data included in security communications received from the Internet-of-things device, if the communication associated with the Internet-of-things device should be allowed,
in response to a determination that the communication associated with the Internet-of-things device should not be allowed, taking, by the gateway, an action to limit the communication, and
in response to a determination that the communication should be allowed, allowing, by the gateway, the communication.

2. The system of claim 1, wherein the Internet-of-things device communicates with the gateway via an Internet-of-things network that comprises the Internet-of-things device and the gateway.

3. The system of claim 2, the Internet-of-things device is onboarded by the gateway by performing operations comprising:
detecting an onboarding request from the Internet-of-things device;
prompting the Internet-of-things device to obtain a hardware verification; and
in response to determining that the hardware verification is received, onboarding the Internet-of-things device.

4. The system of claim 3, wherein the hardware verification comprises detecting manipulation of a hardware device to generate an input at the Internet-of-things device.

5. The system of claim 4, wherein the hardware verification comprises verifying that an output by the hardware device has been detected at the Internet-of-things device.

6. The system of claim 1, the computer-executable instructions, when executed by the processor, cause the processor to perform operations further comprising:
generating, at the gateway, display data comprising renderable data for presenting a user interface that depicts the communication;
receiving, at the gateway, input comprising selection of a user interface element to modify an aspect of the communication; and
triggering, by the gateway, blocking of the communication based on the input.

7. A method comprising:
detecting, at a gateway comprising a processor that executes an Internet-of-things hub, a communication associated with an Internet-of-things device, wherein the communication comprises an attempt for the Internet-of-things device to communicate with another device;
determining, by the processor and based on connection data included in security communications received from the Internet-of-things device, if the communication associated with the Internet-of-things device should be allowed;
in response to a determination that the communication associated with the Internet-of-things device should not be allowed, taking, by the processor, an action to limit the communication; and
in response to a determination that the communication should be allowed, allowing, by the processor, the communication.

8. The method of claim 7, wherein the Internet-of-things device communicates with the gateway via an Internet-of-things network that comprises the Internet-of-things device and the gateway.

9. The method of claim 8, the Internet-of-things device is onboarded by the gateway by performing operations comprising:
detecting an onboarding request from the Internet-of-things device;
prompting the Internet-of-things device to obtain a hardware verification; and
in response to determining that the hardware verification is received, onboarding the Internet-of-things device.

10. The method of claim 9, wherein the hardware verification comprises detecting manipulation of a hardware device to generate an input at the Internet-of-things device.

11. The method of claim 10, wherein the hardware verification comprises verifying that an output by the hardware device has been detected at the Internet-of-things device.

12. The method of claim 11, wherein the hardware device comprises one of a light device or a sound device.

13. The method of claim 7, further comprising:
generating, at the gateway, display data comprising renderable data for presenting a user interface that depicts the communication;
receiving, at the gateway, input comprising selection of a user interface element to modify an aspect of the communication; and
triggering, by the gateway, modification of the communication based on the input.

14. The method of claim 13, wherein the modification of the communication comprises blocking the communication.

15. A computer storage medium having computer-executable instructions stored thereon that, when executed by a processor, cause the processor to perform operations comprising:
detecting, at a gateway that hosts an Internet-of-things hub, a communication associated with an Internet-of-things device, wherein the communication comprises an attempt for the Internet-of-things device to communicate with another device,
determining, by the gateway and based on connection data included in security communications received from the Internet-of-things device, if the communication associated with the Internet-of-things device should be allowed,
in response to a determination that the communication associated with the Internet-of-things device should not be allowed, taking, by the gateway, an action to limit the communication, and
in response to a determination that the communication should be allowed, allowing, by the gateway, the communication.

16. The computer storage medium of claim 15, wherein the Internet-of-things device communicates with the gateway via an Internet-of-things network that comprises the Internet-of-things device and the gateway.

17. The computer storage medium of claim 16, the Internet-of-things device is onboarded by the gateway by performing operations comprising:
detecting an onboarding request from the Internet-of-things device;
prompting the Internet-of-things device to obtain a hardware verification; and
in response to determining that the hardware verification is received, onboarding the Internet-of-things device.

18. The computer storage medium of claim 17, wherein the hardware verification comprises detecting manipulation of a hardware device to generate an input at the Internet-of-things device.

19. The computer storage medium of claim 18, wherein the hardware verification comprises verifying that an output by the hardware device has been detected at the Internet-of-things device.

20. The computer storage medium of claim 15, the computer-executable instructions, when executed by the processor, cause the processor to perform operations further comprising:
generating, at the gateway, display data comprising renderable data for presenting a user interface that depicts the communication;
receiving, at the gateway, input comprising selection of a user interface element to modify an aspect of the communication; and
triggering, by the gateway, blocking of the communication based on the input.
